(19) United States
(12) Patent Application Publication
(10) Pub. No.: US 2024/0097208 A1
(43) Pub. Date: Mar. 21, 2024

(54) MIXTURES AND/OR LAYERS COMPRISING CERAMIC PARTICLES AND A POLYMERIC SURFACTANT, AND RELATED ARTICLES AND METHODS

(71) Applicant: Sion Power Corporation, Tucson, AZ (US)

(72) Inventors: Zhongchun Wang, Sunnyvale, CA (US); Yuriy V. Mikhaylik, Tucson, AZ (US)

(73) Assignee: Sion Power Corporation, Tucson, AZ (US)

(21) Appl. No.: 18/270,720

(22) PCT Filed: Dec. 20, 2021
(86) PCT No.: PCT/US2021/064370

§ 371 Date: Jun. 30, 2023

Related U.S. Application Data
(60) Provisional application No. 63/134,354, filed on Jan. 6, 2021.

(51) Int. Cl. H01M 10/42; C04B 35/634; H01M 4/36

(52) U.S. Cl. CPC H01M 10/4235; C04B 35/63488; H01M 4/366

(57) ABSTRACT

Mixtures and/or layers comprising ceramic particles and a polymeric surfactant are generally described. Related articles (e.g., electrodes, separators, and/or electrochemical cells) and related methods (e.g., methods of forming them and/or methods of using them) are also described.

### RELATED APPLICATIONS

This application claims priority to U.S. Provisional Application No. 63/134,354, filed Jan. 6, 2021, which is incorporated herein by reference in its entirety.

### TECHNICAL FIELD

Mixtures and/or layers comprising ceramic particles and a polymeric surfactant are generally described. Related articles (e.g., electrodes, separators, and/or electrochemical cells) and related methods (e.g., methods of forming them and/or methods of using them) are also described.

### BACKGROUND

Milling (e.g., wet ball-milling) of solid electrolytes is frequently used to produce powder particles for coating electrochemical cell components (e.g., electrodes). However, these techniques frequently produce powder particles that are too large (e.g., have a large diameter), have too wide of a size (e.g., diameter) distribution, and/or have too much agglomeration, which may make them difficult to use with many coating techniques and/or for coating certain electrochemical cell components (e.g., separators). Additionally, while some milling techniques in other fields may be capable of producing smaller particles, they may result in particles that are too small and/or may use additives that are not appropriate in the context of an electrochemical cell (e.g., additives that are soluble in liquid electrolytes). Accordingly, articles and methods for achieving particles of a size and size distribution suitable for use with electrochemical cells would be beneficial.

### SUMMARY

Mixtures and/or layers comprising ceramic particles and a polymeric surfactant are generally described. Related articles (e.g., electrodes, separators, and/or electrochemical cells) and related methods (e.g., methods of forming them and/or methods of using them) are also described. The subject matter of the present invention involves, in some cases, interrelated products, alternative solutions to a particular problem, and/or a plurality of different uses of one or more systems and/or articles.

Certain embodiments are related to mixtures. In some embodiments, the mixture comprises a plurality of ceramic particles and a polymeric surfactant; wherein the plurality of ceramic particles has a median diameter of greater than or equal to 600 nanometers and less than or equal to 6 microns.

In some embodiments, the mixture comprises a plurality of ceramic particles and a polymeric surfactant; wherein the polymeric surfactant has a molecular weight of greater than or equal to 300 g/mol.

Certain embodiments are related to layers. In some embodiments, the layer comprises a plurality of ceramic particles, wherein at least a portion of the plurality of particles are fused to one another, and a polymeric surfactant; wherein prior to fusion, the plurality of ceramic particles has a median diameter of greater than or equal to 600 nanometers and less than or equal to 6 microns.

In some embodiments, the layer comprises a plurality of ceramic particles, wherein at least a portion of the plurality of particles are fused to one another, and a polymeric surfactant; wherein the polymeric surfactant has a molecular weight of greater than or equal to 300 g/mol.

Certain embodiments are related to methods. In some embodiments, the method comprises milling a mixture comprising a plurality of ceramic particles and a polymeric surfactant to form a milled mixture; wherein the plurality of ceramic particles has a median diameter of greater than or equal to 600 nanometers and less than or equal to 6 microns.

In some embodiments, the method comprises milling a mixture comprising a plurality of ceramic particles and a polymeric surfactant to form a milled mixture; wherein the polymeric surfactant has a molecular weight of greater than or equal to 300 g/mol.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A shows, in accordance with some embodiments, a mixture comprising ceramic particles and a polymeric surfactant.

FIG. 1B shows, in accordance with some embodiments, a mixture comprising ceramic particles, a polymeric surfactant, and a solvent.

FIG. 2A shows, in accordance with some embodiments, a layer (e.g., a layer formed by an aerosol deposition method) comprising ceramic particles and a polymeric surfactant, wherein at least a portion of the plurality of particles are fused to one another.

FIG. 2B shows, in accordance with some embodiments, an electrochemical cell comprising the layer of FIG. 2A, optionally wherein the layer coats an electrochemical cell component (e.g., an electrode or a separator).

FIG. 2C shows, in accordance with some embodiments, an electrochemical cell, wherein any combination of the depicted components may optionally be included in the electrochemical cell in any combination, such as the layer of FIG. 2A, an electrochemical cell component (e.g., an electrode or separator), an electrolyte and/or an electrode.

FIG. 3 shows, in accordance with some embodiments, the particle size distribution of Comparator Example 1.

FIG. 4 shows, in accordance with some embodiments, the particle size distribution of Comparator Example 2.

FIG. 5 shows, in accordance with some embodiments, the particle size distribution of Example 1.

FIG. 6 shows, in accordance with some embodiments, the particle size distribution of Example 2.

FIG. 7 shows, in accordance with some embodiments, the particle size distribution of Example 3.

FIG. 8 shows, in accordance with some embodiments, the particle size distribution of Example 4.

FIG. 9 shows, in accordance with some embodiments, the particle size distribution of Example 5.

FIG. 10 shows, in accordance with some embodiments, the particle size distribution of Example 6.

FIG. 11 shows, in accordance with some embodiments, the particle size distribution of Example 7.

FIG. 12 shows, in accordance with some embodiments, the particle size distribution of Example 8.

FIG. 13 shows, in accordance with some embodiments, the particle size distribution of Example 9.

FIG. 14 shows, in accordance with some embodiments, the particle size distribution of Example 10.

FIG. 15 shows, in accordance with some embodiments, an XRD pattern of Example 10.

FIG. 16 shows, in accordance with some embodiments, the particle size distribution of Example 11.

FIG. 17 shows, in accordance with some embodiments, the particle size distribution of Example 12.

FIG. 18 shows, in accordance with some embodiments, SEM images of Example 10 with 1,000 times magnification.

FIG. 19 shows, in accordance with some embodiments, the particle size distribution of Example 14.

FIG. 20 shows, in accordance with some embodiments, an SEM image of Example 14.

FIG. 21 shows, in accordance with some embodiments, an XRD pattern of Li₂₂SiP₂S₁₈ powder.

FIG. 22 shows, in accordance with some embodiments, an electrochemical cell to which an anisotropic force is applied.

FIG. 23 shows, in accordance with some embodiments, an SEM image of Example 17.

### DETAILED DESCRIPTION

Mixtures and/or layers comprising ceramic particles and a polymeric surfactant, related articles (e.g., electrodes, separators, and/or electrochemical cells), and related methods (e.g., methods of forming them and/or methods of using them) are generally described. In some embodiments, milling (e.g., wet ball-milling) a mixture comprising a combination of a polymeric surfactant and a plurality of ceramic particles results in ceramic particles with improved characteristics (e.g., a more desirable size (e.g., a smaller size (e.g., diameter)), a smaller size distribution, and/or reduced agglomeration) over ceramic particles produced from milling a mixture without the polymeric surfactant, all other factors being equal.

In some embodiments, an electrochemical cell component (e.g., an electrode and/or a separator) is coated with the milled mixture (e.g., via atmospheric slurry, via an aerosol deposition method (ADM) process, via paste spreading, and/or via paste extrusion) forming a layer. In some embodiments, the improved characteristics (e.g., a more desirable size (e.g., a smaller size (e.g., diameter)), a smaller size distribution, and/or reduced agglomeration) of the milled mixture facilities this coating.

In some embodiments, the particles and/or mixtures described herein are suitable for forming a layer by an ADM process. As discussed in more detail below, an ADM process generally comprises depositing (e.g., spraying) particles (e.g., inorganic particles, ceramic particles, polymeric particles) at a relatively high velocity on a surface. Aerosol deposition, as described herein, generally results in the collision and/or elastic deformation of at least some of the plurality of ceramic particles provided herein. In some embodiments, ceramic particles that are too large may not be suitable for coating a separator (e.g., ceramic particles that are too large may have too much velocity when using techniques such as ADM, such that they go through and/or damage the separator), but the milled mixture described herein may be suitable for coating a separator. As another example, in some embodiments, ceramic particles that are too large or have too wide of a size distribution (e.g., a size distribution that includes a significant percentage of ceramic particles that are too large) may not be suitable for ADM, while the milled mixture described herein may be suitable for ADM.

As yet another example, in some embodiments, ceramic particles that are too small may not be suitable for use under certain conditions or with certain methods, such as with ADM, as they would not have enough impact energy to fuse to one another. Still further, in some embodiments, if the ceramic particles are too small, their increased surface area per volume of ceramic particles would make them impractical for certain uses. For example, as the surface area of the ceramic particles increase, more polymeric surfactant is required to achieve the same effects described herein, in some embodiments.

In some embodiments, a layer described herein (e.g., formed via ADM) comprises the plurality of ceramic particles and the polymeric surfactant. In some embodiments, at least a portion of the plurality of ceramic particles are fused to one another. In some embodiments, the layer coats an electrochemical cell component, such as an electrode (e.g., an electroactive material) and/or a separator. In some embodiments, the electrochemical cell comprises other components, such as an electrolyte (e.g., a liquid electrolyte). In some embodiments, the ceramic particles and/or the polymeric surfactant of the layer are chemically stable in the electrolyte, such that the layer acts as a protective layer (e.g., from diffusion of ions from an electrode to the electrolyte and/or reaction (e.g., oxidation and/or reduction) of electrolyte components on an electrode surface). In some embodiments, an electrochemical cell comprising a layer described herein (e.g., disposed on an electrode and/or a separator) has improved cycle life compared to an electrochemical cell without the layer, all other factors being equal. For example, in some embodiments where an electrochemical cell comprises a layer described herein disposed on a separator, the separator has improved thermal stability and/or improved mechanical robustness compared to an electrochemical cell without the layer, all other factors being equal.

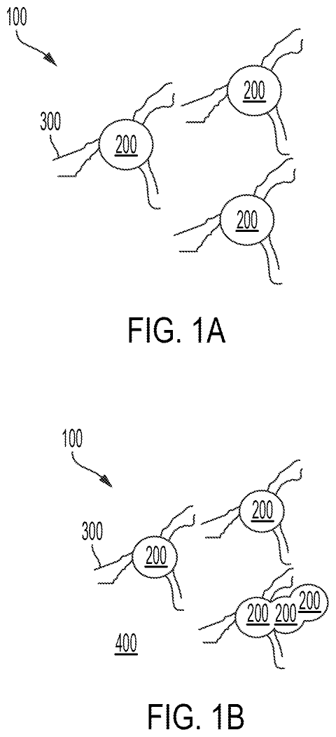

Mixtures are described herein. Some such mixtures are illustrated schematically in FIGS. 1A-1B. In some embodiments, the mixture comprises a plurality of ceramic particles and a polymeric surfactant. For example, in FIG. 1A, in some embodiments, mixture 100 comprises ceramic particles 200 and polymeric surfactant 300.

Without wishing to be bound by theory, it is believed that addition of a polymeric surfactant may have several advantages compared to mixtures and/or layers without the polymeric surfactant, all other factors being equal. For example, in some embodiments, addition of a polymeric surfactant to ceramic particles may reduce the surface energy between ceramic particles and/or cause steric stabilization (e.g., during milling), such that the ceramic particles are able to be closer to one another, which may result in smaller sized particles (e.g., after milling), a more narrow distribution in particle sizes (e.g., after milling), and/or improved fusion of ceramic particles (e.g., in a layer). As another example, in some embodiments, addition of a polymeric surfactant may result in increased flexibility in an article comprising the ceramic particles and polymeric surfactant (e.g., in a layer).

The polymeric surfactant may comprise any suitable material. In some embodiments, the polymeric surfactant comprises a polyacrylic acid, polyethylene glycol (e.g., PEG400, polyethylene glycol tert-octylphenyl ether—Triton X-100), polyvinylpyrrolidone (e.g., PVP40, PVP8), CMC, silicon polymeric surfactant, polysaccharide, polysulfonate, sulphonated styrene/maleic anhydride co-polymer, polyacrylamide, polyvinylidene fluoride, and/or polyvinylidene chloride.

In some embodiments, a carboxylic acid is absent from the polymeric surfactant. Without wishing to be bound by theory, it is believed that, in some embodiments, carboxylic acids are undesirably reactive with the ceramic particles and/or are undesirably soluble in the electrolyte.

In some embodiments, the polymeric surfactant may have a relatively large molecular weight. For example, in some embodiments, the polymeric surfactant has a molecular weight of greater than or equal to 300 g/mol, greater than or equal to 400 g/mol, greater than or equal to 500 g/mol, greater than or equal to 750 g/mol, greater than or equal to 1,000 g/mol, greater than or equal to 1,500 g/mol, greater than or equal to 2,000 g/mol, greater than or equal to 3,000 g/mol, greater than or equal to 4,000 g/mol, greater than or equal to 5,000 g/mol, greater than or equal to 7,000 g/mol, greater than or equal to 10,000 g/mol, greater than or equal to 15,000 g/mol, greater than or equal to 20,000 g/mol, greater than or equal to 25,000 g/mol, greater than or equal to 30,000 g/mol, or greater than or equal to 35,000 g/mol. In some embodiments, the polymeric surfactant has a molecular weight of less than or equal to 100,000 g/mol, less than or equal to 90,000 g/mol, less than or equal to 80,000 g/mol, less than or equal to 70,000 g/mol, less than or equal to 60,000 g/mol, less than or equal to 50,000 g/mol, less than or equal to 45,000 g/mol, or less than or equal to 40,000 g/mol. Combinations of these ranges are also possible (e.g., greater than or equal to 300 g/mol and less than or equal to 100,000 g/mol or greater than or equal to 2,000 g/mol and less than or equal to 100,000 g/mol). Without wishing to be bound by theory, it is believed that polymeric surfactants with a relatively large molecular weight (e.g., greater than or equal to 300 g/mol, greater than or equal to 400 g/mol, or greater than or equal to 2,000 g/mol) typically have lower solubility in the environment of an electrochemical cell (e.g., in an electrolyte), which may be desirable, as it may reduce and/or prevent side reactions with the polymeric surfactant.

The mixture (e.g., milled mixture) and/or layer may comprise any suitable amount of polymeric surfactant. For example, in some embodiments, the mixture (e.g., milled mixture) and/or layer comprises less than or equal to 50 wt. %, less than or equal to 40 wt. %, less than or equal to 30 wt. %, less than or equal to 20 wt. %, less than or equal to 15 wt. %, or less than or equal to 10 wt. % polymeric surfactant. In some embodiments, the mixture (e.g., milled mixture) and/or layer comprises greater than or equal to 0.5 wt. %, greater than or equal to 1 wt. %, greater than or equal to 2 wt. %, greater than or equal to 3 wt. %, greater than or equal to 4 wt. %, greater than or equal to 5 wt. %, greater than or equal to 10 wt. %, or greater than or equal to 15 wt. % polymeric surfactant. Combinations of the these ranges are also possible (e.g., greater than or equal to 0.5 wt. % and less than or equal to 50 wt. %, greater than or equal to 1 wt. % and less than or equal to 20 wt. %, greater than or equal to 5 wt. % and less than or equal to 20 wt. %, or greater than or equal to 5 wt. % and less than or equal to 10 wt. %).

In some embodiments, adding a polymeric surfactant to the mixture (e.g., milled mixture) and/or layer may result in an undesirable drop in ionic conductivity (e.g., lithium ion conductivity). Without wishing to be bound by theory, it is believed that reducing and/or minimizing the drop in ionic conductivity (e.g., lithium ion conductivity) of the mixture (e.g., milled mixture) and/or a layer comprising the mixture (e.g., milled mixture) when the polymeric surfactant is added is beneficial (e.g., for use in an electrochemical cell). In some embodiments, the amount and/or type of the polymeric surfactant in the mixture (e.g., milled mixture) and/or layer is selected to reduce and/or minimize the drop in conductivity of the mixture and/or layer when the polymeric surfactant is added. For example, in some embodiments, the amount and/or type of the polymeric surfactant in the mixture (e.g., milled mixture) and/or layer reduces the conductivity of the mixture (e.g., milled mixture) and/or layer by less than or equal to 50 times, less than or equal to 40 times, less than or equal to 30 times, less than or equal to 20 times, less than or equal to 10 times, less than or equal to 5 times, less than or equal to 3 times, or less than or equal to 2 times from the conductivity of a mixture (e.g., milled mixture) and/or layer without the polymeric surfactant, all other factors being equal. In some embodiments, the amount of the polymeric surfactant in the mixture (e.g., milled mixture) and/or layer reduces the conductivity of the mixture and/or layer by greater than or equal to 1.1 times, greater than or equal to 1.3 times, greater than or equal to 1.5 times, greater than or equal to 2 times, or greater than or equal to 5 times from the conductivity of a mixture (e.g., milled mixture) and/or layer without the polymeric surfactant, all other factors being equal. Combinations of these ranges are also possible (e.g., greater than or equal to 1.1 times and less than or equal to 50 times). For example, if a mixture (e.g., milled mixture) and/or layer without the polymeric surfactant had a conductivity of 100 S/m, and a mixture (e.g., milled mixture) and/or layer with the polymeric surfactant, all other factors being equal, had a conductivity of 10 S/m, then the amount of the polymeric surfactant in the latter mixture (e.g., milled mixture) and/or layer reduced the conductivity of the mixture and/or layer by 10 times because it is 1/10 of the conductivity of the mixture and/or layer without the polymeric surfactant.

The ceramic particles may comprise any suitable material. In some embodiments, the ceramic particles comprise a composition as in formula (I):

Li₂ₓS_{x+w+5z}M_{y}P_{2z} (I),

where x is 8-16, y is 0.1-6, w is 0.1-15, z is 0.1-3, and M is selected from the group consisting of Lanthanides, Group 3, Group 4, Group 8, Group 12, Group 13, and Group 14 atoms, and combinations thereof.

In some embodiments, the ceramic particles comprise a composition as in formula (I) and x is 8-16, 8-12, 10-12, 10-14, or 12-16. In some embodiments x is 8 or greater, 8.5 or greater, 9 or greater, 9.5 or greater, 10 or greater, 10.5 or greater, 11 or greater, 11.5 or greater, 12 or greater, 12.5 or greater, 13 or greater, 13.5 or greater, 14 or greater, 14.5 or greater, 15 or greater, or 15.5 or greater. In certain embodiments, x is less than or equal to 16, less than or equal to 15.5, less than or equal to 15, less than or equal to 14.5, less than or equal to 14, less than or equal to 13.5, less than or equal to 13, less than or equal to 12.5, less than or equal to 12, less than or equal to 11.5, less than or equal to 11, less than or equal to 10.5, less than or equal to 10, less than or equal to 9.5, or less than or equal to 9. Combinations of the above referenced ranges are also possible (e.g., greater than or equal to 8 and less than or equal to 16, greater than or equal to 10 and less than or equal to 12). Other ranges are also possible. In some embodiments, x is 10. In some embodiments, x is 12.

In some embodiments, the ceramic particles comprise a composition as in formula (I) and y is 0.1-6, 0.1-1, 0.1-3, 0.1-4.5, 0.1-6, 0.8-2, 1-4, 2-4.5, 3-6 or 1-6. For example, in some embodiments, y is 1. In some embodiments, y is greater than or equal to 0.1, greater than or equal to 0.2, greater than or equal to 0.4, greater than or equal to 0.5, greater than or equal to 0.6, greater than or equal to 0.8, greater than or equal to 1, greater than or equal to 1.2, greater than or equal to 1.4, greater than or equal to 1.5, greater than or equal to 1.6, greater than or equal to 1.8, greater than or equal to 2.0, greater than or equal to 2.2, greater than or equal to 2.4, greater than or equal to 2.5, greater than or equal to 2.6, greater than or equal to 2.8, greater than or equal to 3.0, greater than or equal to 3.5, greater than or equal to 4.0, greater than or equal to 4.5, greater than or equal to 5.0, or greater than or equal to 5.5. In certain embodiments, y is less than or equal to 6, less than or equal to 5.5, less than or equal to 5.0, less than or equal to 4.5, less than or equal to 4.0, less than or equal to 3.5, less than or equal to 3.0, less than or equal to 2.8, less than or equal to 2.6, less than or equal to 2.5, less than or equal to 2.4, less than or equal to 2.2, less than or equal to 2.0, less than or equal to 1.8, less than or equal to 1.6, less than or equal to 1.5, less than or equal to 1.4, less than or equal to 1.2, less than or equal to 1.0, less than or equal to 0.8, less than or equal to 0.6, less than or equal to 0.5, less than or equal to 0.4, or less than or equal to 0.2. Combinations of the above-referenced ranges are also possible (e.g., greater than or equal to 0.1 and less than or equal to 6.0, greater than or equal to 1 and less than or equal to 6, greater than or equal to 1 and less than or equal to 3, greater than or equal to 0.1 and less than or equal to 4.5, greater than or equal to 1.0 and less than or equal to 2.0). Other ranges are also possible. In embodiments in which a compound of formula (I) includes more than one M, the total y may have a value in one or more of the above-referenced ranges and in some embodiments may be in the range of 0.1-6.

In some embodiments, the ceramic particles comprise a composition as in formula (I) and z is 0.1-3, 0.1-1, 0.8-2, or 1-3. For example, in some embodiments, z is 1. In some embodiments, z is greater than or equal to 0.1, greater than or equal to 0.2, greater than or equal to 0.4, greater than or equal to 0.5, greater than or equal to 0.6, greater than or equal to 0.8, greater than or equal to 1, greater than or equal to 1.2, greater than or equal to 1.4, greater than or equal to 1.5, greater than or equal to 1.6, greater than or equal to 1.8, greater than or equal to 2.0, greater than or equal to 2.2, greater than or equal to 2.4, greater than or equal to 2.5, greater than or equal to 2.6, or greater than or equal to 2.8. In certain embodiments, z is less than or equal to 3.0, less than or equal to 2.8, less than or equal to 2.6, less than or equal to 2.5, less than or equal to 2.4, less than or equal to 2.2, less than or equal to 2.0, less than or equal to 1.8, less than or equal to 1.6, less than or equal to 1.5, less than or equal to 1.4, less than or equal to 1.2, less than or equal to 1.0, less than or equal to 0.8, less than or equal to 0.6, less than or equal to 0.5, less than or equal to 0.4, or less than or equal to 0.2. Combinations of the above-referenced ranges are also possible (e.g., greater than or equal to 0.1 and less than or equal to 3.0, greater than or equal to 1.0 and less than or equal to 2.0). Other ranges are also possible.

In certain embodiments, the ratio of y to z is greater than or equal to 0.03, greater than or equal to 0.1, greater than or equal to 0.25, greater than or equal to 0.5, greater than or equal to 0.75, greater than or equal to 1, greater than or equal to 2, greater than or equal to 4, greater than or equal to 8, greater than or equal to 10, greater than or equal to 15, greater than or equal to 20, greater than or equal to 25, greater than or equal to 30, greater than or equal to 40, greater than or equal to 45, or greater than or equal to 50. In some embodiments, the ratio of y to z is less than or equal to 60, less than or equal to 50, less than or equal to 45, less than or equal to 40, less than or equal to 30, less than or equal to 25, less than or equal to 20, less than or equal to 15, less than or equal to 10, less than or equal to 8, less than or equal to 4, less than or equal to 3, less than or equal to 2, less than or equal to 1, less than or equal to 0.75, less than or equal to 0.5, less than or equal to 0.25, or less than or equal to 0.1. Combinations of the above-referenced ranges are also possible (e.g., a ratio of y to z of greater than or equal to 0.1 and less than or equal to 60, a ratio of y to z of greater than or equal to 0.1 and less than or equal to 10, greater than or equal to 0.25 and less than or equal to 4, or greater than or equal to 0.75 and less than or equal to 2). In some embodiments, the ratio of y to z is 1.

In some embodiments, the ceramic particles comprise a composition as in formula (I) and w is 0.1-15, 0.1-1, 0.8-2, 1-3, 1.5-3.5, 2-4, 2.5-5, 3-6, 4-8, 6-10, 8-12, or 10-15. For example, in some embodiments, w is 1. In some cases, w may be 1.5. In certain embodiments, w is 2. In some embodiments, w is greater than or equal to 0.1, greater than or equal to 0.2, greater than or equal to 0.4, greater than or equal to 0.5, greater than or equal to 0.6, greater than or equal to 0.8, greater than or equal to 1, greater than or equal to 1.5, greater than or equal to 2, greater than or equal to 2.5, greater than or equal to 3, greater than or equal to 4, greater than or equal to 6, greater than or equal to 8, greater than or equal to 10, greater than or equal to 12, or greater than or equal to 14. In certain embodiments, w is less than or equal to 15, less than or equal to 14, less than or equal to 12, less than or equal to 10, less than or equal to 8, less than or equal to 6, less than or equal to 4, less than or equal to 3, less than or equal to 2.5, less than or equal to 2, less than or equal to 1.5, less than or equal to 1, less than or equal to 0.8, less than or equal to 0.6, less than or equal to 0.5, less than or equal to 0.4, or less than or equal to 0.2. Combinations of the above-referenced ranges are also possible (e.g., greater than or equal to 0.1 and less than or equal to 15, greater than or equal to 1.0 and less than or equal to 3.0). Other ranges are also possible.

In an exemplary embodiment, the ceramic particles comprise a composition as in Li₁₆S₁₅MP₂. In another exemplary embodiment, the ceramic particles comprise a composition as in Li₂₀S₁₇MP₂. In yet another exemplary embodiment, the ceramic particles comprise a composition as in Li₂₄S₁₉MP₂. For example, in some embodiments, the ceramic particles comprise a composition according to a formula selected from the group consisting of Li₁₆S₁₅MP₂, Li₂₀S₁₇MP₂ and Li₂₄S₁₉MP₂.

In some embodiments, w is equal to y. In certain embodiments, w is equal to 1.5y. In other embodiments, w is equal to 2y. In yet other embodiments, w is equal to 2.5y. In yet further embodiments, w is equal to 3y. Without wishing to be bound by theory, those skilled in the art would understand that the value of w may, in some cases, depend upon the valency of M. For example, in some embodiments, M is a tetravalent atom, w is 2y, and y is 0.1-6. In certain embodiments, M is a trivalent atom, w is 1.5y, and y is 0.1-6. In some embodiments, M is a bivalent atom, w is equal to y, and y is 0.1-6. Other valences and values for w are also possible.

In some embodiments, the ceramic particles comprise a composition as in formula (I) and M is tetravalent, x is 8-16, y is 0.1-6, w is 2y, and z is 0.1-3. In some such embodiments, the ceramic particles comprise a composition as in formula (II):

Li₂ₓS_{x+2y+5z}M_{y}P_{2z} (II),

where x is 8-16, y is 0.1-6, z is 0.1-3, and M is tetravalent and selected from the group consisting of Lanthanides, Group 4, Group 8, Group 12, and Group 14 atoms, and combinations thereof. In an exemplary embodiment, M is Si, x is 10.5, y is 1, and z is 1 such that the compound of formula (II) is Li₂₁S_{17.5}SiP₂.

In some embodiments, the ceramic particles comprise a composition as in formula (I) and M is trivalent, x is 8-16, y is 1, w is 1.5y, and z is 1. In some such embodiments, the ceramic particles comprise a composition as in formula (III):

Li₂ₓS_{x+1.5y+5z}M_{y}P_{2z} (III),

where x is 8-16, y is 0.1-6, z is 0.1-3, and M is trivalent and selected from the group consisting of Lanthanides, Group 3, Group 4, Group 8, Group 12, Group 13, and Group 14 atoms, and combinations thereof. In an exemplary embodiment, M is Ga, x is 10.5, y is 1, and z is 1 such that the compound of formula (III) is Li₂₁S₁₇GaP₂.

In some embodiments, M is a Group 4 (i.e. IUPAC Group 4) atom such as zirconium. In certain embodiments, M is a Group 8 (i.e. IUPAC Group 8) atom such as iron. In some embodiments, M is a Group 12 (i.e. IUPAC Group 12) atom such as zinc. In certain embodiments, M is a Group 13 (i.e. IUPAC Group 13) atom such as aluminum. In some embodiments, M is a Group 14 (i.e. IUPAC Group 14) atom such as silicon, germanium, or tin. In some cases, M may be selected from the groups consisting of Lanthanides, Group 3, Group 4, Group 8, Group 12, Group 13, and/or Group 14 atoms. For example, in some embodiments, M may be selected from silicon, tin, germanium, zinc, iron, zirconium, aluminum, and combinations thereof. In certain embodiments, M is selected from silicon, germanium, aluminum, iron and zinc.

In some cases, M may be a combination of two or more atoms selected from the groups consisting of Lanthanides, Group 3, Group 4, Group 8, Group 12, Group 13, and Group 14 atoms. That is, in certain embodiments in which M includes more than one atom, each atom (i.e. each atom M) may be independently selected from the group consisting of Lanthanides, Group 3, Group 4, Group 8, Group 12, Group 13, and Group 14 atoms. In some embodiments, M is a single atom. In certain embodiments, M is a combination of two atoms. In other embodiments, M is a combination of three atoms. In some embodiments, M is a combination of four atoms. In some embodiments, M may be a combination of one or more monovalent atoms, one or more bivalent atoms, one or more trivalent atoms, and/or one or more tetravalent atoms selected from the groups consisting of Lanthanides, Group 3, Group 4, Group 8, Group 12, Group 13, and Group 14 atoms.

In such embodiments, the stoichiometric ratio of each atom in M may be such that the total amount of atoms present in M is y and is 0.1-6, or any other suitable range described herein for y. For example, in some embodiments, M is a combination of two atoms such that the total amount of the two atoms present in M is y and is 0.1-6. In certain embodiments, each atom is present in M in substantially the same amount and the total amount of atoms present in M is y and within the range 0.1-6, or any other suitable range described herein for y. In other embodiments, each atom may be present in M in different amounts and the total amount of atoms present in M is y and within the range 0.1-6, or any other suitable range described herein for y. In an exemplary embodiment, the ceramic particles comprise a composition as in formula (I) and each atom in M is either silicon or germanium and y is 0.1-6. For example, in such an embodiment, each atom in M may be either silicon or germanium, each present in substantially the same amount, and y is 1 since M_{y} is SiO_{0.5}Ge_{0.5}. In another exemplary embodiment, the ceramic particles comprise a composition as in formula (I) and each atom in M may be either silicon or germanium, each atom present in different amounts such that M_{y} is Si_{y-p}Geₚ, where p is between 0 and y (e.g., y is 1 and p is 0.25 or 0.75). Other ranges and combinations are also possible. Those skilled in the art would understand that the value and ranges of y, in some embodiments, may depend on the valences of M as a combination of two or more atoms, and would be capable of selecting and/or determining y based upon the teachings of this specification. As noted above, in embodiments in which a compound of formula (I) includes more than one atom in M, the total y may be in the range of 0.1-6.

In an exemplary embodiment, M is silicon. For example, in some embodiments, the ceramic particles comprise Li₂ₓS_{x+w+5z}Si_{y}P_{2z}, where x is greater than or equal to 8 and less than or equal to 16, y is greater than or equal to 0.1 and less than or equal to 3, w is equal to 2y, and z is greater than or equal to 0.1 and less than or equal to 3. Each x, y and z may independently be chosen from the values and ranges of x, y and z described above, respectively. For example, in one particular embodiment, x is 10, y is 1, and z is 1, and the ceramic particles comprise Li₂₀S₁₇SiP₂. In some embodiments, x is 10.5, y is 1, and z is 1, and the ceramic particles comprise Li₂₁S_{17.5}SiP₂. In certain embodiments, x is 11, y is 1, and z is 1, and the ceramic particles comprise Li₂₂S₁₈SiP₂. In certain embodiments, x is 12, y is 1, and z is 1, and the ceramic particles comprise Li₂₄S₁₉SiP₂. In some cases, x is 14, y is 1, and z is 1, and the ceramic particles comprise Li₂₈S₂₁SiP₂.

It should be appreciated that while much of the above description herein relates to ceramic particles where y is 1, z is 1, w is 2y, and comprises silicon, other combinations of values for w, x, y, and z and elements for M are also possible. For example, in some cases, M is Ge and the ceramic particles may comprise Li₂ₓS_{x+w+5z}Ge_{y}P_{2z}, where x is greater than or equal to 8 and less than or equal to 16, y is greater than or equal to 0.1 and less than or equal to 3, w is equal to 2y, and z is greater than or equal to 0.1 and less than or equal to 3. Each w, x, y and z may independently be chosen from the values and ranges of w, x, y and z described above, respectively. For example, in one particular embodiment, w is 2, x is 10, y is 1, and z is 1, and the ceramic particles comprise Li₂₀S₁₇GeP₂. In certain embodiments, w is 2, x is 12, y is 1, and z is 1, and the ceramic particles comprise Li₂₄S₁₉GeP₂. In some cases, w is 2, x is 14, y is 1, and z is 1, and the ceramic particles comprise Li₂₈S₂₁GeP₂. Other stoichiometric ratios, as described above, are also possible.

In certain embodiments, M is Sn and the ceramic particles comprise may comprise Li₂ₓS_{x+w+5z}Sn_{y}P_{2z}, where x is greater than or equal to 8 and less than or equal to 16, y is greater than or equal to 0.1 and less than or equal to 3, w is equal to 2y, and z is greater than or equal to 0.1 and less than or equal to 3. Each w, x, y and z may independently be chosen from the values and ranges of w, x, y and z described above, respectively. For example, in one particular embodiment, w is 2, x is 10, y is 1, and z is 1, and the ceramic particles comprise Li₂S₁₇SnP₂. In certain embodiments, w is 2, x is 12, y is 1, and z is 1, and the ceramic particles comprise Li₂₄S₁₉SnP₂. In some cases, w is 2, x is 14, y is 1, and z is 1, and the ceramic particles comprise Li₂₈S₂₁SnP₂. Other stoichiometric ratios, as described above, are also possible.

In some embodiments, the ceramic particles comprise glass and/or a glassy-ceramic material. In some embodiments, the ceramic particles comprise lithium-based sulfides and/or oxides. In some embodiments, the ceramic particles comprise Li₇La₃Zr₂O₁₂ (LLZO), Li₂₂SiP₂S₁₈, antiperovskite, beta-alumina, sulfide glass, oxide glass, lithium phosphorus oxinitride, Li replaceable NASICON ceramic, Li_{1+x+y}AlₓTi₂₋ₓSi_{y}P_{3-y}O₁₂ (where x is between 0 and 2 and y is between 0 and 1.25). Li₂O—Al₂O₃—SiO₂—P₂O₅—TiO₂—GeO₂, Li₂O—Al₂O₃—SiO₂—P₂O₅—TiO₂, and/or lithium borosilicate glass. The ceramic particles may be crystalline, amorphous, or partially crystalline and partially amorphous.

The ceramic particles (e.g., prior to fusion and/or after milling) may have any suitable median diameter. For example, in some embodiments, the ceramic particles (e.g., prior to fusion and/or after milling) have a median diameter of greater than or equal to 600 nanometers, greater than or equal to 700 nanometers, greater than or equal to 800 nanometers, greater than or equal to 900 nanometers, greater than or equal to 1 micron, greater than or equal to 2 microns, greater than or equal to 3 microns, greater than or equal to 4 microns, or greater than or equal to 5 microns. In some embodiments, the ceramic particles (e.g., prior to fusion and/or after milling) have a median diameter of less than or equal to 6 microns, less than or equal to 5.5 microns, less than or equal to 5 microns, less than or equal to 4.5 microns, less than or equal to 4 microns, less than or equal to 3 microns, less than or equal to 2 microns, or less than or equal to 1 microns. Combinations of these ranges are also possible (e.g., greater than or equal to 600 nm and less than or equal to 6 microns or greater than or equal to 1 micron and less than or equal to 4 microns).

Without wishing to be bound by theory, it is believed that having ceramic particles in a particular size range (e.g., a range of median diameter) may be advantageous over smaller ceramic particles and/or larger ceramic particles. For example, if the ceramic particles are smaller (e.g., have smaller median diameters) than the ceramic particles within such a size range, in some embodiments, they will not be suitable for certain uses and/or with certain techniques. For example, particles that are too small may not have enough impact energy to fuse under certain conditions, such as certain conditions for aerosol deposition methods (ADM). As another example, if the ceramic particles are smaller (e.g., have smaller median diameters) than the ceramic particles within a particular size range, in some embodiments, their increased surface area per volume of ceramic particles would make them impractical for some uses disclosed herein, as it would require too much of the polymeric surfactant (e.g., if the amount of polymeric surfactant required is directly proportional to approximately 1/diameter, in some embodiments). Similarly, if the ceramic particles are larger (e.g., have larger median diameters) than the ceramic particles within a particular size range, in some embodiments, they will not be suitable for certain uses and/or with certain techniques, such as with ADM or for coating a separator (i.e., if the size is too large, then the impact energy will be too large, and the ceramic particles would go through and/or damage the separator rather than coating the separator, in some embodiments).

In some embodiments, the diameter of the ceramic particles (e.g., prior to fusion, in the mixture, and/or after milling) has a narrow distribution. For example, in some embodiments, at least 80%, at least 85%, at least 90%, or at least 95% of the ceramic particles (e.g., prior to fusion and/or after milling) have a diameter of less than or equal to 30 microns, less than or equal to 25 microns, less than or equal to 20 microns, less than or equal to 17 microns, less than or equal to 15 microns, less than or equal to 12 microns, or less than or equal to 10 microns. As another example, in some embodiments, at least 80%, at least 85%, at least 90%, or at least 95% of the ceramic particles (e.g., prior to fusion and/or after milling) have a diameter of greater than or equal to 500 nanometers, greater than or equal to 600 nanometers, greater than or equal to 700 nanometers, greater than or equal to 800 nanometers, greater than or equal to 900 nanometers, or greater than or equal to 1 micron. Combinations of these ranges are also possible. For example, in some embodiments, at least 80%, at least 85%, at least 90%, or at least 95% of the ceramic particles have a diameter of less than or equal to 30 microns and at least 80%, at least 85%, at least 90%, or at least 95% of the ceramic particles have a diameter of greater than or equal to 500 nanometers. As another example, in some embodiments, at least 80%, at least 85%, at least 90%, or at least 95% of the ceramic particles have a diameter of less than or equal to 20 microns and at least 80%, at least 85%, at least 90%, or at least 95% of the ceramic particles have a diameter of greater than or equal to 600 nanometers.

In some embodiments, the diameter of the ceramic particles (e.g., prior to fusion, in the mixture, and/or after milling) has a standard deviation of less than or equal to 10 microns, less than or equal to 9 microns, less than or equal to 8 microns, less than or equal to 7 microns, less than or equal to 6 microns, less than or equal to 5 microns, less than or equal to 4 microns, less than or equal to 3 microns, less than or equal to 2 microns, or less than or equal to 1 micron. In some embodiments, the diameter of the ceramic particles (e.g., prior to fusion, in the mixture, and/or after milling) has a standard deviation of greater than or equal to 0 microns, greater than or equal to 0.01 microns, greater than or equal to 0.05 microns, greater than or equal to 0.1 microns, greater than or equal to 0.2 microns, greater than or equal to 0.3 microns, greater than or equal to 0.4 microns, greater than or equal to 0.5 microns, greater than or equal to 0.6 microns, greater than or equal to 0.7 microns, greater than or equal to 0.8 microns, or greater than or equal to 0.9 microns. Combinations of these ranges are also possible (e.g., greater than or equal to 0 microns and less than or equal to 10 microns, greater than or equal to 0 microns and less than or equal to 6 microns, or greater than or equal to 0.9 and less than or equal to 6 microns).

In some embodiments, the ceramic particles have a narrower distribution in diameter than ceramic particles (e.g., after milling, in a mixture, and/or in a layer) without the polymeric surfactant (e.g., milled without the polymeric surfactant), all other factors being equal. For example, in some embodiments, the ceramic particles have a narrower distribution in diameter after milling (e.g., without filtering for size) than ceramic particles milled without the polymeric surfactant, all other factors being equal.

The ceramic particles (e.g., prior to fusion and/or after milling) may have a low polydispersity index in volume. In some embodiments, the ceramic particles have a polydispersity index in volume of less than or equal to 0.5, less than or equal to 0.4, less than or equal to 0.3, or less than or equal to 0.2. In some embodiments, the ceramic particles have a polydispersity index in volume of greater than or equal to 0.01, greater than or equal to 0.05, or greater than or equal to 0.1. Combinations of these ranges are also possible (e.g., greater than or equal to 0.01 and less than or equal to 0.5). As used herein, the polydispersity index is (the standard deviation in volume/mean volume)².

Without wishing to be bound by theory, it is believed that a narrow distribution in diameter and/or aspect ratio and/or a low polydispersity index in volume of the ceramic particles may be advantageous over broader distributions and/or higher polydispersity indices. For example, as described above, having ceramic particles of a certain size (e.g., certain median diameter) may be advantageous over smaller ceramic particles and/or larger ceramic particles, and having a narrow distribution in diameter and/or a low polydispersity index in volume results in a larger percentage of the ceramic particles being within the desired size range, in some embodiments. For example, in some embodiments where the milled mixture is applied to an electrochemical cell component (e.g., electrode and/or separator) using ADM, ceramic particles with a diameter over a certain size may not be used and may remain in the feeder rather than being applied to the electrochemical cell component. The amount and/or percentage of the ceramic particles that are unusable and/or wasted may be larger the wider the distribution in size. Moreover, having a narrow distribution in diameter and/or a low polydispersity index in volume results in more consistent and/or uniform results, in some embodiments. Still further, having a narrow distribution in diameter and/or a low polydispersity index facilitates, in some embodiments, precise tuning of the particle velocity and impact energy for the desired fusion.

In some embodiments, the ceramic particles have a low aspect ratio. For example, in some embodiments, the ceramic particles have an aspect ratio of greater than or equal to 1, greater than or equal to 2, greater than or equal to 3, greater than or equal to 4, greater than or equal to 5, greater than or equal to 6, greater than or equal to 7, greater than or equal to 8, or greater than or equal to 9. In some embodiments, the ceramic particles have an aspect ratio of less than or equal to 10, less than or equal to 9, less than or equal to 8, less than or equal to 7, less than or equal to 6, less than or equal to 5, less than or equal to 4, less than or equal to 3, or less than or equal to 2. Combinations of these ranges are also possible (e.g., greater than or equal to 1 and less than or equal to 10 or greater than or equal to 1 and less than or equal to 5). As used herein, the aspect ratio is the ratio of the longest dimension of the particle to the shortest dimension of the particle. For example, a perfect sphere would have an aspect ratio of 1, as the diameter would be the same throughout the sphere such that it would be both the shortest dimension and the longest dimension.

The mixture (e.g., milled mixture) and/or layer may comprise any suitable amount of ceramic particles. In some embodiments, the mixture (e.g., milled mixture) and/or layer comprises greater than or equal to 0.5 wt. %, greater than or equal to 1 wt. %, greater than or equal to 5 wt. %, greater than or equal to 10 wt. %, greater than or equal to 20 wt. %, greater than or equal to 30 wt. %, greater than or equal to 40 wt. %, greater than or equal to 50 wt. %, greater than or equal to 60 wt. %, greater than or equal to 70 wt. %, greater than or equal to 80 wt. %, greater than or equal to 85 wt. %, greater than or equal to 90 wt. %, greater than or equal to 95 wt. %, greater than or equal to 96 wt. %, greater than or equal to 97 wt. %, or greater than or equal to 98 wt. % ceramic particles. In some embodiments, the mixture (e.g., milled mixture) and/or layer comprises less than or equal to 99 wt. %, less than or equal to 98 wt. %, less than or equal to 97 wt. %, less than or equal to 96 wt. %, less than or equal to 95 wt. %, less than or equal to 90 wt. %, less than or equal to 85 wt. %, less than or equal to 80 wt. %, less than or equal to 70 wt. %, less than or equal to 60 wt. %, less than or equal to 50 wt. %, less than or equal to 40 wt. %, less than or equal to 30 wt. %, less than or equal to 20 wt. %, or less than or equal to 10 wt. % ceramic particles. Combinations of these ranges are also possible (e.g., greater than or equal to 0.5 wt. % and less than or equal to 99 wt. %, greater than or equal to 50 wt. % and less than or equal to 99 wt. %, greater than or equal to 60 wt. % and less than or equal to 99 wt. %, greater than or equal to 70 wt. % and less than or equal to 99 wt. %, greater than or equal to 10 wt. % and less than or equal to 70 wt. %, or greater than or equal to 30 wt. % and less than or equal to 60 wt. %).

In some embodiments, at least some (e.g., at least 50%, at least 75%, at least 90%, at least 95%, or at least 99%) or all of the plurality of ceramic particles (e.g., in a mixture, before milling, during milling, and/or after milling) are individual particles. For example, in some embodiments, at least some (e.g., at least 50%, at least 75%, at least 90%, at least 95%, or at least 99%) or all of the plurality of ceramic particles (e.g., in a mixture, before milling, during milling, and/or after milling) are not fused to any other ceramic particles. For example, in FIG. 1A, in some embodiments, 100% of ceramic particles 200 are individual particles that are not fused to one or more ceramic particles. In contrast, in FIG. 1B, in some embodiments, 40% of ceramic particles 200 are individual particles that are not fused to one or more ceramic particles, while 60% of ceramic particles 200 are not individual particles, as they are fused to one or more ceramic particles.

In some embodiments, the mixture is a powder. In some embodiments, the mixture is a slurry. In some embodiments, the mixture (e.g., slurry) comprises a solvent. For example, in FIG. 1B, in some embodiments, the mixture comprises solvent 400.

The mixture (e.g., milled mixture) may comprise any suitable amount of solvent. In some embodiments, the mixture (e.g., milled mixture) comprises greater than or equal to 30 wt. %, greater than or equal to 35 wt. %, greater than or equal to 40 wt. %, greater than or equal to 50 wt. %, greater than or equal to 60 wt. %, greater than or equal to 70 wt. %, or greater than or equal to 80 wt. % solvent. In some embodiments, the mixture (e.g., milled mixture) comprises less than or equal to 90 wt. %, less than or equal to 85 wt. %, less than or equal to 80 wt. %, less than or equal to 75 wt. %, less than or equal to 70 wt. %, less than or equal to 60 wt. %, less than or equal to 50 wt. %, or less than or equal to 40 wt. % solvent. Combinations of these ranges are also possible (e.g., greater than or equal to 30 wt. % and less than or equal to 90 wt. % or greater than or equal to 40 wt. % and less than or equal to 70 wt. %).

The solvent may comprise any suitable solvent (e.g., any solvent chemically compatible with solid components). Examples of suitable solvents include organic solvents (e.g., hexane and/or heptane), nonpolar solvents (e.g., hexane and/or heptane), polar solvents, and/or solvents that are chemically inert towards one or more components in the mixture (e.g., the ceramic particles and/or polymeric surfactant). In some embodiments, the solvent may be any solvent disclosed herein.

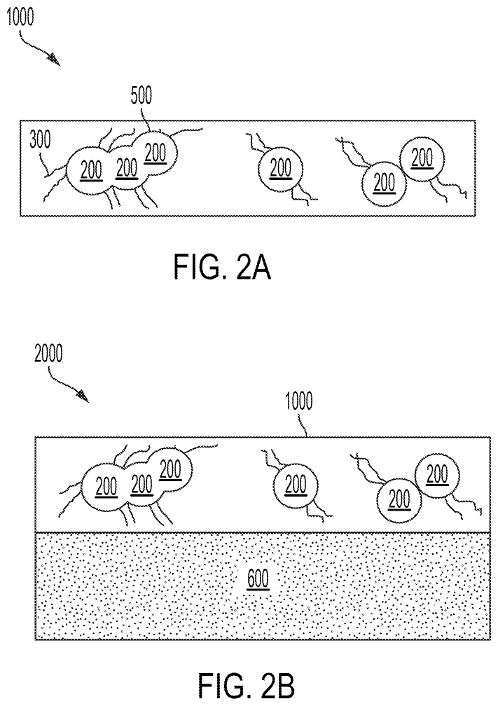

Methods are also described herein. Some such methods can be understood in relation to FIGS. 1A-2C.

In some embodiments, a method comprises fracturing ceramic particles (e.g., by imparting sufficient stress, such as compression stress and/or impact stress, to the ceramic particles to result in fracturing) to reduce the average ceramic particle size. Examples of suitable fracturing methods may include compression between two rigid surfaces, compression between surfaces and an adjacent bed of solids, use of shearing forces by mechanical means (e.g., tearing, cleaving, cutting or shredding), use of shearing forces due to surrounding media, use of high-velocity impact against a rigid surface, use of particle-particle impact that causes breakage and shattering, and/or abrasion during particle-wall and particle-particle impacts. In some embodiments, the fracturing method comprises milling (e.g., wet-ball milling). Although embodiments are described herein in relation to milling, it should be understood that other fracturing methods can be used in place of milling in any such embodiments.

In some embodiments, a method comprises milling a mixture (e.g., any mixture disclosed herein), such as a mixture comprising a plurality of ceramic particles (e.g., any ceramic particles disclosed herein) and a polymer surfactant (e.g., any polymeric surfactant disclosed herein), to form a milled mixture. For example, in some embodiments, the method comprises milling mixture 100 of FIG. 1A, which comprises a plurality of ceramic particles 200 and polymeric surfactant 300. In some embodiments, the milling comprising mechanical milling. Non-limiting examples of mechanical milling include ball milling, wet ball milling, and/or high energy ball milling.

In some embodiments, the mixture (e.g., prior to and/or during milling) and/or milled mixture comprises beads. In some embodiments, the beads have an average hardness higher than the average hardness of the ceramic particles (e.g., to reduce ceramic particle size during milling by friction). Non-limiting examples of suitable beads may comprise alumina, stainless steel, silicate glass, agate, yttria stabilized zirconia, zirconium silicate, zirconia toughened alumina, tungsten carbide, and/or zirconium dioxide (ZrO₂).

In some embodiments, the method comprises drying the mixture (e.g., after milling). In some embodiments, drying the mixture (e.g., milled mixture) comprises any drying methods with conditions that are not destructive to the polymeric surfactant and/or ceramic particles.

In some embodiments, drying the mixture (e.g., milled mixture) comprises drying under vacuum. For examples, in some embodiments, drying the mixture (e.g., milled mixture) comprises drying in a container in which vacuum is applied to the container. In some embodiments, the vacuum pressure within the container is at least 0.5 mTorr, at least 1 mTorr, at least 2 mTorr, at least 5 mTorr, at least 10 mTorr, at least 20 mTorr, or at least 50 mTorr. In some embodiments, the vacuum pressure within the container is less than or equal to 100 mTorr, less than or equal to 50 mTorr, less than or equal to 20 mTorr, less than or equal to 10 mTorr, less than or equal to 5 mTorr, less than or equal to 2 mTorr, or less than or equal to 1 mTorr. Combinations of the above-referenced ranges are also possible (e.g., at least 0.5 mTorr and less than or equal to 100 mTorr). Other ranges are also possible.

The mixture (e.g., milled mixture) may be dried at any suitable temperature. In some embodiments, the mixture (e.g., milled mixture) is dried at a temperature greater than or equal to room temperature, greater than or equal to 30° C., greater than or equal to 40° C., greater than or equal to 50° C., greater than or equal to 60° C., greater than or equal to 70° C., greater than or equal to 80° C., greater than or equal to 90° C., greater than or equal to 100° C., greater than or equal to 110° C., or greater than or equal to 120° C. In some embodiments, the mixture (e.g., milled mixture) is dried at a temperature of less than or equal to 150° C., less than or equal to 140° C., less than or equal to 130° C., less than or equal to 120° C., less than or equal to 110° C., less than or equal to 100° C., or less than or equal to 90° C. Combinations of these ranges are also possible (e.g., greater than or equal to room temperature and less than or equal to 150° C. or greater than or equal to 110° C. and less than or equal to 130° C.).

The mixture (e.g., milled mixture) may be dried for any suitable time period. In some embodiments, the mixture (e.g., milled mixture) is dried for a time period of greater than or equal to 30 minutes, greater than or equal to 1 hour, greater than or equal to 2 hours, greater than or equal to 3 hours, greater than or equal to 5 hours, greater than or equal to 12 hours, or greater than or equal to 24 hours. In some embodiments, the mixture is dried for a time period of less than or equal to 72 hours, less than or equal to 48 hours, less than or equal to 24 hours, less than or equal to 12 hours, less than or equal to 5 hours, or less than or equal to 3 hours. Combinations of these ranges are also possible (e.g., greater than or equal to 30 minutes and less than or equal to 72 hours or greater than or equal to 1 hour and less than or equal to 3 hours).

In some embodiments, the method comprises separating the beads from the mixture (e.g., after milling and/or drying) (e.g., milled mixture) to form a powder. The beads may be separated from the mixture (e.g., milled mixture) by any suitable method. In some embodiments, the beads are separated from the mixture (e.g., milled mixture) based on size (e.g., with a sieve). In some embodiments, the method comprises combining the mixture (e.g., milled mixture) with a solvent (e.g., any solvent described herein).

In some embodiments, the method comprises applying the mixture (e.g., after milling and/or drying, with or without a solvent) and/or powder (e.g., after milling, drying, and/or removal of the beads) to a substrate. Non-limiting examples of suitable substrates include components of an electrochemical cell. For example, in some embodiments, the method comprises applying the mixture (e.g., milled mixture) and/or powder to an electrode (e.g., an anode and/or cathode) and/or a separator.

The mixture (e.g., milled mixture) and/or powder may be applied to the substrate using any suitable methods. In some embodiments, the method comprises applying the mixture (e.g., milled mixture) and/or power to the substrate as a slurry (e.g., under atmospheric conditions).

In some embodiments, the method comprises applying the mixture (e.g., milled mixture) and/or powder to the substrate (e.g., an electrode and/or a separator) using ADM. Non-limiting examples of suitable methods of ADM include those described in U.S. Pat. Pub. No. 2016/0344067, U.S. Pat. No. 9,825,328, U.S. Pat. Pub. No. 2017/0338475, and U.S. Pat. Pub. No. 2018/0351148, each of which are incorporated herein by reference in their entirety and for all purposes. In some embodiments, a process described herein for forming a layer and/or a sublayer thereof can be carried out such that the bulk properties of the precursor materials (e.g., ceramic particles) are maintained in the resulting layer (e.g., crystallinity, ion-conductivity). In some embodiments, using ADM provides more regularly shaped ceramic particles (e.g., as demonstrated by a low aspect ratio) than other methods.

In some embodiments, applying the mixture (e.g., milled mixture) and/or powder to a substrate forms a layer (e.g., a layer disposed on and/or coating the substrate, such as an electrode and/or a separator). In some embodiments, the layer may be any layer disclosed herein.

In some embodiments, the method comprises forming an electrochemical cell comprising the substrate (e.g., the electrode and/or separator). For example, in some embodiments, the method comprises combining the substrate (e.g., an electrode and/or a separator coated with a layer disclosed herein) with other electrochemical components, such as one or more electrodes, a separator, an electrolyte, and/or a current collector.

Layers comprising the particles and surfactants described herein are also provided. One such layer is illustrated schematically in FIG. 2A.

In some embodiments, the layer comprises a plurality of ceramic particles (e.g., any ceramic particles disclosed herein) and a polymeric surfactant (e.g., any polymeric surfactant disclosed herein). For example, in FIG. 2A, in some embodiments, layer 1000 comprises a plurality of ceramic particles 200 and polymeric surfactant 300.

In some embodiments, at least a portion of the plurality of the ceramic particles are fused to one another. For example, in FIG. 2A, in some embodiments, layer 1000 comprises fused ceramic particles 500. In some embodiments, at least 30%, at least 50%, at least 75%, at least 80%, at least 85%, at least 90%, at least 95%, or at least 99% of the ceramic particles are fused to at least one other ceramic particle. In some embodiments, less than or equal to 100%, less than or equal to 99%, less than or equal to 95%, less than or equal to 90%, less than or equal to 85%, less than or equal to 80%, less than or equal to 75%, or less than or equal to 50% of the ceramic particles are fused to at least one other ceramic particle. Combinations of these ranges are also possible (e.g., at least 30% and less than or equal to 100%, at least 50% and less than or equal to 100%, or at least 80% and less than or equal to 100%). In some embodiments, 100% of the ceramic particles are fused to at least one other ceramic particle.

In some embodiments, at least a portion of the plurality of ceramic particles are bound to the polymeric surfactant. For example, in FIG. 2A, in some embodiments, at least a portion of the plurality of ceramic particles 200 are bound to polymeric surfactant 300. In some embodiments, at least 30%, at least 50%, at least 75%, at least 80%, at least 85%, at least 90%, at least 95%, or at least 99% of the ceramic particles are bound to at least one polymeric surfactant. In some embodiments, less than or equal to 100%, less than or equal to 99%, less than or equal to 95%, less than or equal to 90%, less than or equal to 85%, less than or equal to 80%, less than or equal to 75%, or less than or equal to 50% of the ceramic particles are bound to at least one polymeric surfactant. Combinations of these ranges are also possible (e.g., at least 30% and less than or equal to 100%, at least 50% and less than or equal to 100%, or at least 80% and less than or equal to 100%). In some embodiments, 100% of the ceramic particles are bound to at least one polymeric surfactant.

In some embodiments, the polymeric surfactant functions as a binder and/or facilitates binding of particles in the layer. In some embodiments, a layer described herein may be more flexible than a layer without the polymeric surfactant, all other factors being equal. For example, in some embodiments, a layer described herein may have a relatively low modulus of elasticity. The low modulus of elasticity may be indicative of a layer that is relatively deformable (e.g., that deforms upon the application of a relatively low amount of force). This may advantageously allow the layer to be compacted in a relatively facile manner to yield a layer having a relatively low surface area. As electroactive materials (e.g., lithium) present at the surface of a layer may undesirably undergo a depletion reaction with the electrolyte, layers having relatively low surface areas are believed to advantageously reduce the rate at which such reactions occur and/or to reduce the total amount of such reactions that occur over the lifetime of the electrochemical cell.

In some embodiments, a layer has a modulus of elasticity of less than 4.9 GPa, less than or equal to 4.5 GPa, less than or equal to 4.25 GPa, less than or equal to 4 GPa, less than or equal to 3.75 GPa, less than or equal to 3.5 GPa, less than or equal to 3.25 GPa, less than or equal to 3 GPa, less than or equal to 2.75 GPa, less than or equal to 2.5 GPa, less than or equal to 2.25 GPa, less than or equal to 2 GPa, less than or equal to 1.75 GPa, less than or equal to 1.5 GPa, less than or equal to 1.25 GPa, or less than or equal to 1 GPa. In some embodiments, a layer has a modulus of elasticity of greater than or equal to 0.75 GPa, greater than or equal to 1 GPa, greater than or equal to 1.25 GPa, greater than or equal to 1.5 GPa, greater than or equal to 1.75 GPa, greater than or equal to 2 GPa, greater than or equal to 2.25 GPa, greater than or equal to 2.5 GPa, greater than or equal to 2.75 GPa, greater than or equal to 3 GPa, greater than or equal to 3.25 GPa, greater than or equal to 3.5 GPa, greater than or equal to 3.75 GPa, greater than or equal to 4 GPa, greater than or equal to 4.25 GPa, or greater than or equal to 4.5 GPa. Combinations of the above-referenced ranges are also possible (e.g., less than 4.9 GPa and greater than or equal to 0.75 GPa, or less than or equal to 4 GPa and greater than or equal to 0.75 GPa). Other ranges are also possible.

The modulus of elasticity of a layer may be determined by performing the procedure described in ASTM E2546 with the following parameters: (1) an approach speed of 1 micron/minute; (2) a contact load of 0.03 mN; (3) a load of between 1-2.5 mN; (4) a loading rate of double the load; and (5) an indentation depth of 1 micron.

As described above, a layer may comprise a layer and/or sublayer comprising a plurality of ceramic particles at least partially fused to one another. The terms “fuse” and “fused” (and “fusion”) are given their typical meaning in the art and generally refers to the physical joining of two or more objects (e.g., ceramic particle(s)) such that they form a single object. For example, in some cases, the volume occupied by a single ceramic particle (e.g., the entire volume within the outer surface of the ceramic particle) prior to fusion is substantially equal to half the volume occupied by two fused ceramic particles. Those skilled in the art would understand that the terms “fuse,” “fused,” and “fusion” do not refer to ceramic particles that simply contact one another at one or more surfaces, but ceramic particles wherein at least a portion of the original surface of each individual ceramic particle can no longer be discerned from the other ceramic particle.

In some embodiments, at least some or all of the fused ceramic particles comprise joined interior portions of the ceramic particles. For example, in FIG. 2A, in some embodiments, layer 1000 comprises fused ceramic particles 500, wherein fused ceramic particles 500 comprise joined interior portions of the ceramic particles. In some embodiments, fusing comprises merging at least a portion of an interior of two or more particles.

The layer may be formed by any suitable method (e.g., any method disclosed herein, such as via atmospheric slurry, ADM, paste spreading, and/or paste extrusion). In some embodiments, the layer is formed by an ADM method. Non-limiting examples of suitable methods of ADM include those described in U.S. Pat. Pub. No. 2016/0344067, U.S. Pat. No. 9,825,328, U.S. Pat. Pub. No. 2017/0338475, and U.S. Pat. Pub. No. 2018/0351148, each of which are incorporated herein by reference in their entirety and for all purposes.

The plurality of ceramic particles that are at least partially fused to one another may extend throughout the layer or through only a portion thereof. When the plurality of ceramic particles that are at least partially fused to one another extend throughout the layer, the layer may be relatively uniform or may vary spatially (e.g., one or more other components of the layer may not extend fully therethrough). When the plurality of ceramic particles that are at least partially fused to one another extend only through a portion of the layer, they may form a discrete sublayer separate from one or more other sublayers of the layer or may interpenetrate with one or more other sublayers. Other morphologies are also possible.

For instance, a plurality of ceramic particles that are at least partially fused to one another may form a relatively uniform layer together with one or more of the components described elsewhere herein. In some such embodiments, the plurality of ceramic particles that are at least partially fused to one another may, together with this component(s), form an interpenetrating structure. The interpenetrating structure may be a three-dimensional structure and/or may span the thickness of the layer.

In some embodiments, a layer comprises a first sublayer comprising a plurality of ceramic particles that are at least partially fused to one another, and a second sublayer. The second sublayer may have one or more features described elsewhere herein with respect to layers as a whole. When a layer comprises two or more sublayers, the sublayers may be positioned with respect to each other in a variety of suitable manners. For instance, a layer may comprise a sublayer comprising a plurality of ceramic particles that are at least partially fused to one another that is directly adjacent to an electrode (e.g., an anode and/or a cathode) or may comprise a sublayer comprising a plurality of ceramic particles that are at least partially fused to one another that is separated from an electrode by one or more intervening layers (e.g., intervening layers having one or more features described elsewhere herein with respect to layers as a whole). In some embodiments, a sublayer comprising a plurality of ceramic particles that are at least partially fused to one another is the outermost sublayer of a multilayer layer.

In some cases, a plurality of ceramic particles that are at least partially fused to one another is fused such that at least a portion of the plurality of ceramic particles forms a continuous pathway across the layer and/or sublayer thereof (e.g., between a first surface of the layer and a second, opposing, surface of the layer; between a first surface of the sublayer and a second, opposing, surface of the sublayer). A continuous pathway may include, for example, an ionically-conductive pathway from a first surface to a second, opposing surface of the layer and/or sublayer thereof in which there are substantially no gaps, breakages, or discontinuities in the pathway. While fused ceramic particles across a layer may form a continuous pathway, a pathway including packed, unfused ceramic particles may have gaps or discontinuities between the ceramic particles that would not render the pathway continuous. Such gaps and/or discontinuities may be filled (completely or partially) by another component of the layer and/or sublayer thereof.

In some embodiments, a plurality of ceramic particles that are at least partially fused to one another forms a plurality of such continuous pathways across the layer and/or sublayer thereof. In some embodiments, at least 10 vol %, at least 30 vol %, at least 50 vol %, or at least 70 vol % of the layer and/or sublayer thereof comprises one or more continuous pathways comprising fused ceramic particles (e.g., which may comprise an ionically conductive material). In some embodiments, less than or equal to 100 vol %, less than or equal to 90 vol %, less than or equal to 70 vol %, less than or equal to 50 vol %, less than or equal to 30 vol %, less than or equal to 10 vol %, or less than or equal to 5 vol % of the layer and/or sublayer thereof comprises one or more continuous pathways comprising fused ceramic particles. Combinations of the above-referenced ranges are also possible (e.g., at least 10 vol % and less than or equal to 100 vol %). In some cases, 100 vol % of a sublayer of a layer comprises one or more continuous pathways comprising fused ceramic particles. That is to say, in some embodiments, a sublayer of the layer consists essentially of fused ceramic particles (e.g., the second layer comprises substantially no unfused ceramic particles). In other embodiments, the layer lacks unfused ceramic particles and/or is substantially free from unfused ceramic particles.

Those skilled in the art would be capable of selecting suitable methods for determining if ceramic particles (and/or polymeric surfactant) are fused including, for example, performing Confocal Raman Microscopy (CRM). CRM may be used to determine the percentage of fused areas within a layer and/or sublayer thereof. For instance, in some aspects the fused areas may be less crystalline (more amorphous) compared to the unfused areas (e.g., ceramic particles) within the layer and/or sublayer thereof, and may provide different Raman characteristic spectral bands than those of the unfused areas. In some embodiments, the fused areas may be amorphous and the unfused areas (e.g., ceramic particles) within the layer may be crystalline. Crystalline and amorphous areas may have peaks at the same/similar wavelengths, while amorphous peaks may be broader/less intense than those of crystalline areas. In some instances, the unfused areas may include spectral bands substantially similar to the spectral bands of the bulk ceramic particles prior to formation of the layer (the bulk spectrum). For example, an unfused area may include peaks at the same or similar wavelengths and having a similar area under the peak (integrated signal) as the peaks within the spectral bands of the ceramic particles prior to formation of the layer. An unfused area may have, for instance, an integrated signal (area under the peak) for the largest peak (the peak having the largest integrated signal) in the spectrum that may be, e.g., within at least 70%, at least 75%, at least 80%, at least 85%, at least 90%, at least 95%, or at least 97% of the value of the integrated signal for the corresponding largest peak of the bulk spectrum. By contrast, the fused areas may include spectral bands different from (e.g., peaks at the same or similar wavelengths but having a substantially different/lower integrated signal than) the spectral bands of the ceramic particles prior to formation of the layer. A fused area may have, for instance, an integrated signal (area under the peak) for the largest peak (the peak having the largest integrated signal) in the spectrum that may be, e.g., less than 50%, less than 60%, less than 70%, less than 75%, less than 80%, less than 85%, less than 90%, less than 95%, or less than 97% of the value of the integrated signal for the corresponding largest peak of the bulk spectrum.

In some embodiments, two dimensional and/or three dimensional mapping of CRM may be used to determine the percentage of fused areas in a layer and/or sublayer thereof (e.g., the percentage of area, within a minimum cross-sectional area, having an integrated signal for the largest peak of the spectrum that differs from that for the ceramic particles prior to formation of the layer, as described above).

As described above, some methods relate to forming a portion of a layer and/or a sublayer of a layer by an aerosol deposition process. Aerosol deposition processes generally comprise depositing (e.g., spraying) particles (e.g., inorganic particles, polymeric particles) at a relatively high velocity on a surface. Aerosol deposition, as described herein, generally results in the collision and/or elastic deformation of at least some of the plurality of ceramic particles. In some aspects, aerosol deposition can be carried out under conditions (e.g., using a velocity) sufficient to cause fusion of at least some of the plurality of ceramic particles to at least another portion of the plurality of ceramic particles. For example, in some embodiments, a plurality of ceramic particles is deposited on an electrode (and/or any sublayer(s) disposed thereon) at a relatively high velocity such that at least a portion of the plurality of ceramic particles fuse (e.g., forming the portion and/or sublayer of the layer). The velocity required for ceramic particle fusion may depend on factors such as the material composition of the ceramic particles, the size of the ceramic particles, the Young's elastic modulus of the ceramic particles, and/or the yield strength of the ceramic particles or material forming the ceramic particles.

In some embodiments, a plurality of ceramic particles is deposited at a velocity sufficient to cause fusion of at least some of the ceramic particles therein. It should be appreciated, however, that in some aspects, the ceramic particles are deposited at a velocity such that at least some of the ceramic particles are not fused. In some aspects, the velocity of the ceramic particles is at least 150 m/s, at least 200 m/s, at least 300 m/s, at least 400 m/s, or at least 500 m/s, at least 600 m/s, at least 800 m/s, at least 1000 m/s, or at least 1500 m/s. In some embodiments, the velocity is less than or equal to 2000 m/s, less than or equal to 1500 m/s, less than or equal to 1000 m/s, less than or equal to 800 m/s, less than or equal to 600 m/s, less than or equal to 500 m/s, less than or equal to 400 m/s, less than or equal to 300 m/s, or less than or equal to 200 m/s. Combinations of the above-referenced ranges are also possible (e.g., at least 150 m/s and less than or equal to 2000 m/s, at least 150 m/s and less than or equal to 600 m/s, at least 200 m/s and less than or equal to 500 m/s, at least 200 m/s and less than or equal to 400 m/s, or at least 500 m/s and less than or equal to 2000 m/s). Other velocities are also possible. In some embodiments in which more than one particle type is included in a layer and/or sublayer thereof, each particle type may be deposited at a velocity in one or more of the above-referenced ranges.

In some embodiments, a plurality of ceramic particles to be at least partially fused is deposited by a method that comprises spraying the ceramic particles (e.g., via aerosol deposition) on the surface of an electrode (and/or any sublayer(s) disposed thereon) and/or separator by pressurizing a carrier gas with the ceramic particles. In some embodiments, the pressure of the carrier gas is at least 5 psi, at least 10 psi, at least 20 psi, at least 50 psi, at least 90 psi, at least 100 psi, at least 150 psi, at least 200 psi, at least 250 psi, or at least 300 psi. In some embodiments, the pressure of the carrier gas is less than or equal to 350 psi, less than or equal to 300 psi, less than or equal to 250 psi, less than or equal to 200 psi, less than or equal to 150 psi, less than or equal to 100 psi, less than or equal to 90 psi, less than or equal to 50 psi, less than or equal to 20 psi, or less than or equal to 10 psi. Combinations of the above-referenced ranges are also possible (e.g., at least 5 psi and less than or equal to 350 psi). Other ranges are also possible and those skilled in the art would be capable of selecting the pressure of the carrier gas based upon the teachings of this specification. For example, in some embodiments, the pressure of the carrier gas is such that the velocity of the ceramic particles deposited on the electrode (and/or any sublayer(s) disposed thereon) and/or separator is sufficient to fuse at least some of the ceramic particles to one another.

In some aspects, a carrier gas (e.g., the carrier gas transporting a plurality of ceramic particles to be at least partially fused) is heated prior to deposition. In some aspects, the temperature of the carrier gas is at least 20° C., at least 25° C., at least 30° C., at least 50° C., at least 75° C., at least 100° C., at least 150° C., at least 200° C., at least 300° C., or at least 400° C. In some embodiments, the temperature of the carrier gas is less than or equal to 500° C., less than or equal to 400° C., less than or equal to 300° C., less than or equal to 200° C., less than or equal to 150° C., less than or equal to 100° C., less than or equal to 75° C., less than or equal to 50° C., less than or equal to 30° C., or less than or equal to 20° C. Combinations of the above-referenced ranges are also possible (e.g., at least 20° C. and less than or equal to 500° C.). Other ranges are also possible.

In some embodiments, a plurality of ceramic particles to be at least partially fused are deposited under a vacuum environment. For example, the ceramic particles may be deposited on the surface of an electrode (and/or any sublayer(s) disposed thereon) and/or separator in a container in which vacuum is applied to the container (e.g., to remove atmospheric resistance to ceramic particle flow, to permit high velocity of the ceramic particles, and/or to remove contaminants). In some embodiments, the vacuum pressure within the container is at least 0.5 mTorr, at least 1 mTorr, at least 2 mTorr, at least 5 mTorr, at least 10 mTorr, at least 20 mTorr, or at least 50 mTorr. In some embodiments, the vacuum pressure within the container is less than or equal to 100 mTorr, less than or equal to 50 mTorr, less than or equal to 20 mTorr, less than or equal to 10 mTorr, less than or equal to 5 mTorr, less than or equal to 2 mTorr, or less than or equal to 1 mTorr. Combinations of the above-referenced ranges are also possible (e.g., at least 0.5 mTorr and less than or equal to 100 mTorr). Other ranges are also possible.

The ceramic particles and/or mixture may have any suitable average contact angle. For example, in some embodiments, the ceramic particles and/or mixture have an average contact angle of less than 90 degrees, less than or equal to 80 degrees, less than or equal to 70 degrees, less than or equal to 60 degrees, less than or equal to 50 degrees, less than or equal to 40 degrees, less than or equal to 30 degrees, less than or equal to 20 degrees, less than or equal to 10 degrees, less than or equal to 5 degrees, less than or equal to 3 degrees, or less than or equal to 1 degree. In some embodiments, the ceramic particles and/or mixture have an average contact angle of greater than 0 degrees, greater than or equal to 1 degree, greater than or equal to 2 degrees, greater than or equal to 3 degrees, greater than or equal to 4 degrees, greater than or equal to 5 degrees, greater than or equal to 10 degrees, greater than or equal to 20 degrees, greater than or equal to 30 degrees, or greater than or equal to 40 degrees. Combinations of these ranges are also possible (e.g., greater than 0 degrees and less than 90 degrees or greater than 0 degrees and less than or equal to 30 degrees). The contact angle may be measured using the Washburn method, wherein a glass tube with a filter base is filled with the ceramic particles (or a mixture) and placed in contact with a test liquid, which is drawn up the glass tube by capillary action. The increase in mass with respect to time is measured, which is described by the Washburn equation:

$$\frac{{m}^{2}}{t} = \frac{c \cdot {ρ}^{2} \cdot σ \cdot cos θ}{η}$$

where m is the mass of the ceramic particles (or the mixture), t is the flow time, σ is the surface tension of the test liquid, ρ is the density of the test liquid, Θ is the contact angle, c is the capillary constant of the ceramic particles (or the mixture), and η is the viscosity of the test liquid. ρ, η, and σ may be known for a given test liquid. The constant c may be determined by using an optimally wetting test liquid (e.g., n-hexane) where the contact angle would be 0 degrees. The value of the constant c thus determined may then be used in the equation to determine the contact angle. The contact angle may be determined by performing the Washburn method with a variety of other test liquids (e.g., 3 or more, 4 or more, or 5 or more test liquids, for example, with a variety of wetting properties) and taking an average of the various contact angles. Alternatively, the contact angle may be measured using drop shape analysis (DSA), wherein the contact angle is measured using the image of a sessile particle at the points of intersection (three-phase contact points) between the particle contour and the projection of the surface (baseline). The contact angle may be measured using DSA100, DSA30, DSA25, MSA, or MobileDrop as the instrument.

In some embodiments, the average contact angle of the ceramic particles to one another (e.g., in a mixture) is lower than that of ceramic particles without the polymeric surfactant, all other factors being equal. For example, in some embodiments, the average contact angle of the ceramic particles to one another is at least 10%, at least 20%, at least 30%, at least 40%, or at least 50% lower than that of ceramic particles without the polymeric surfactant, all other factors being equal. In some embodiments, the average contact angle of the ceramic particles to one another is less than or equal to 90%, less than or equal to 80%, less than or equal to 70%, or less than or equal to 60% lower than that of ceramic particles without the polymeric surfactant, all other factors being equal. Combinations of these ranges are also possible (e.g., at least 10% and less than or equal to 90%). For example, if the contact angle of ceramic particles to one another without the polymeric surfactant was 120 degrees and the contact angle of ceramic particles to one another with the polymeric surfactant, all other factors being equal, was 80 degrees, then the contact angle would be 33.33% ((120−80)/120*100) lower for the ceramic particles with the polymeric surfactant.

Without wishing to be bound by theory, it is believed that a reduction in contact angle is representative of a reduction in surface energy (e.g., due to the presence of the polymeric surfactant). Similarly, without wishing to be bound by theory, it is believed that a reduction in contact angle (and/or a low contact angle) is representative of a higher affinity (and/or a high affinity) between the ceramic particle and the polymeric surfactant.

The layer may have any suitable thickness. In some embodiments, the layer has a thickness of greater than or equal to 2 microns, greater than or equal to 3 microns, greater than or equal to 4 microns, or greater than or equal to 5 microns. In some embodiments, the layer has a thickness of less than or equal to 15 microns, less than or equal to 13 microns, less than or equal to 10 microns, less than or equal to 8 microns, or less than or equal to 5 microns. Combinations of these ranges are also possible (e.g., greater than or equal to 2 microns and less than or equal to 15 microns or greater than or equal to 2 microns and less than or equal to 5 microns).

In some embodiments, the layer is calendered.

In some embodiments, the layer comprises a protective layer. In some embodiments, the protective layer may be capable of protecting an electrode (e.g., cathode and/or anode) from deleterious reactions with one or more other species also present in the electrochemical cell, such as one or more species present in the electrolyte. In some embodiments, the protective layer has a relatively low resistance.

In some embodiments, the layer comprises a solid electrolyte layer (SEI) and/or a component of an SEI. In some embodiments, the SEI described herein may be advantageous in comparison to other SEIs in one or more ways. By way of example, the SEI described herein may be particularly stable, may function as a protective layer, and/or may have a relatively low resistance.

Electrochemical cells are described herein. Some such electrochemical cells are illustrated schematically in FIGS. 2B-2C. FIGS. 2B-2C show an electrochemical cell, or components thereof, that may comprise one or more advantageous components described herein and/or in which one or more advantageous methods described herein may occur. It should be understood that the electrochemical cells shown in FIGS. 2B-2C may optionally include one or more components not shown, such as a separator, one or more current collectors, housing, external circuitry, additional electrode(s), and the like.

In some embodiments, the electrochemical cell comprises a battery.

In some embodiments, the electrochemical cell comprises a layer (e.g., any layer disclosed herein). In some embodiments, the layer is disposed on and/or coats an electrochemical cell component (e.g., a separator and/or an electrode, such as an anode and/or a cathode). For example, in FIG. 2B, in some embodiments, electrochemical cell 2000 comprises electrochemical cell component 600 (e.g., an electrode and/or separator) and layer 1000 is disposed on and/or coated on electrochemical cell component 600.

In some embodiments, the electrochemical cell comprises an electrolyte. For example, in FIG. 2C, in some embodiments, electrochemical cell 2000 comprises electrolyte 800 and, optionally, other components (e.g., electrochemical cell component 700, electrode 900, and/or layer 1000 disposed on and/or coating electrochemical cell component 700). Suitable non-aqueous electrolytes may include liquid electrolytes, gel polymer electrolytes, and/or solid polymer electrolytes. In some embodiments, the electrolyte (e.g., the liquid electrolyte) comprises a solvent (e.g., an organic solvent) and/or an ionic salt (e.g., a lithium salt). In some embodiments, the electrolyte comprises multiple solvents (e.g., an organic solvent and an aromatic hydrocarbon solvent) and/or an ionic salt (e.g., a lithium salt).

Examples of useful solvents (e.g., non-aqueous liquid electrolyte solvents) include, but are not limited to, non-aqueous organic solvents, such as, for example, N-methyl acetamide, acetonitrile, acetals, ketals, esters (e.g., esters of carbonic acid, sulfonic acid, an/or phosphoric acid), carbonates (e.g., dimethyl carbonate, diethyl carbonate, ethyl methyl carbonate, propylene carbonate, ethylene carbonate, fluoroethylene carbonate, difluoroethylene carbonate), sulfones, sulfites, sulfolanes, suflonimidies (e.g., bis(trifluoromethane)sulfonimide lithium salt), ethers (e.g., aliphatic ethers, acyclic ethers, cyclic ethers), glymes, polyethers, phosphate esters (e.g., hexafluorophosphate), siloxanes, dioxolanes, N-alkylpyrrolidones, nitrate containing compounds, substituted forms of the foregoing, and blends thereof. Examples of acyclic ethers that may be used include, but are not limited to, diethyl ether, dipropyl ether, dibutyl ether, dimethoxymethane, trimethoxymethane, 1,2-dimethoxyethane, diethoxyethane, 1,2-dimethoxypropane, and 1,3-dimethoxypropane. Examples of cyclic ethers that may be used include, but are not limited to, tetrahydrofuran, tetrahydropyran, 2-methyltetrahydrofuran, 1,4-dioxane, 1,3-dioxolane, and trioxane. Examples of polyethers that may be used include, but are not limited to, diethylene glycol dimethyl ether (diglyme), triethylene glycol dimethyl ether (triglyme), tetraethylene glycol dimethyl ether (tetraglyme), higher glymes, ethylene glycol divinyl ether, diethylene glycol divinyl ether, triethylene glycol divinyl ether, dipropylene glycol dimethyl ether, and butylene glycol ethers. Examples of sulfones that may be used include, but are not limited to, sulfolane, 3-methyl sulfolane, and 3-sulfolene. Fluorinated derivatives of the foregoing are also useful as liquid electrolyte solvents.

In some cases, mixtures of the solvents described herein may also be used. For example, in some embodiments, mixtures of solvents are selected from the group consisting of 1,3-dioxolane and dimethoxyethane, 1,3-dioxolane and diethyleneglycol dimethyl ether, 1,3-dioxolane and triethyleneglycol dimethyl ether, and 1,3-dioxolane and sulfolane. In some embodiments, the mixture of solvents comprises dimethyl carbonate and ethylene carbonate. In some embodiments, the mixture of solvents comprises ethylene carbonate and ethyl methyl carbonate. The weight ratio of the two solvents in the mixtures may range, in some cases, from about 5 wt %:95 wt % to 95 wt %:5 wt %. For example, in some embodiments the electrolyte comprises a 50 wt %:50 wt % mixture of dimethyl carbonate:ethylene carbonate. In some other embodiments, the electrolyte comprises a 30 wt %:70 wt % mixture of ethylene carbonate:ethyl methyl carbonate. An electrolyte may comprise a mixture of dimethyl carbonate:ethylene carbonate with a ratio of dimethyl carbonate:ethylene carbonate that is less than or equal to 50 wt %:50 wt % and greater than or equal to 30 wt %:70 wt %.

In some embodiments, an electrolyte may comprise a mixture of fluoroethylene carbonate and dimethyl carbonate. A weight ratio of fluoroethylene carbonate to dimethyl carbonate may be 20 wt %:80 wt % or 25 wt %:75wt %. A weight ratio of fluoroethylene carbonate to dimethyl carbonate may be greater than or equal to 20 wt %:80 wt % and less than or equal to 25 wt %:75 wt %.

Non-limiting examples of suitable gel polymer electrolytes include polyethylene oxides, polypropylene oxides, polyacrylonitriles, polysiloxanes, polyimides, polyphosphazenes, polyethers, sulfonated polyimides, perfluorinated membranes (NAFION resins), polydivinyl polyethylene glycols, polyethylene glycol diacrylates, polyethylene glycol dimethacrylates, derivatives of the foregoing, copolymers of the foregoing, cross-linked and network structures of the foregoing, and blends of the foregoing.

Non-limiting examples of suitable solid polymer electrolytes include polyethers, polyethylene oxides, polypropylene oxides, polyimides, polyphosphazenes, polyacrylonitriles, polysiloxanes, derivatives of the foregoing, copolymers of the foregoing, cross-linked and network structures of the foregoing, and blends of the foregoing.

In some embodiments, an electrolyte is in the form of a layer having a particular thickness. An electrolyte layer may have a thickness of, for example, at least 1 micron, at least 5 microns, at least 10 microns, at least 15 microns, at least 20 microns, at least 25 microns, at least 30 microns, at least 40 microns, at least 50 microns, at least 70 microns, at least 100 microns, at least 200 microns, at least 500 microns, or at least 1 mm. In some embodiments, the thickness of the electrolyte layer is less than or equal to 1 mm, less than or equal to 500 microns, less than or equal to 200 microns, less than or equal to 100 microns, less than or equal to 70 microns, less than or equal to 50 microns, less than or equal to 40 microns, less than or equal to 30 microns, less than or equal to 20 microns, less than or equal to 10 microns, or less than or equal to 5 microns. Other values are also possible. Combinations of the above-noted ranges are also possible.

In some embodiments, the electrolyte comprises at least one salt (e.g., lithium salt). For example, in some cases, the at least one salt (e.g., lithium salt) comprises LiSCN, LiBr, LiI, LiSO₃CH₃, LiNO₃, LiPF₆, LiBF₄, LiB(Ph)₄, LiClO₄, LiAsF₆, Li₂SiF₆, LiSbF₆, LiAlCl₄, an oxalo(borate group) (e.g., lithium bis(oxalato)borate), lithium difluoro(oxalato)borate, a salt comprising a tris(oxalato)phosphate anion (e.g., lithium tris(oxalato)phosphate), LiCF₃SO₃, LiN(SO₂F)₂, LiN(SO₂CF₃)₂, LiC(CₙF₂ₙ₊₁SO₂)₃ wherein n is an integer in the range of from 1 to 20, and (CₙF₂ₙ₊₁SO₂)ₘXLi with n being an integer in the range of from 1 to 20, m being 1 when X is selected from oxygen or sulfur, m being 2 when X is selected from nitrogen or phosphorus, and m being 3 when X is selected from carbon or silicon.

When present, a lithium salt may be present in the electrolyte at a variety of suitable concentrations. In some embodiments, the lithium salt is present in the electrolyte at a concentration of greater than or equal to 0.01 M, greater than or equal to 0.02 M, greater than or equal to 0.05 M, greater than or equal to 0.1 M, greater than or equal to 0.2 M, greater than or equal to 0.5 M, greater than or equal to 1 M, greater than or equal to 2 M, or greater than or equal to 5 M. The lithium salt may be present in the electrolyte at a concentration of less than or equal to 10 M, less than or equal to 5 M, less than or equal to 2 M, less than or equal to 1 M, less than or equal to 0.5 M, less than or equal to 0.2 M, less than or equal to 0.1 M, less than or equal to 0.05 M, or less than or equal to 0.02 M. Combinations of the above-referenced ranges are also possible (e.g., greater than or equal to 0.01 M and less than or equal to 10 M, or greater than or equal to 0.01 M and less than or equal to 5 M). Other ranges are also possible.

In some embodiments, an electrolyte may comprise LiPF₆ in an advantageous amount. In some embodiments, the electrolyte comprises LiPF₆ at a concentration of greater than or equal to 0.01 M, greater than or equal to 0.02 M, greater than or equal to 0.05 M, greater than or equal to 0.1 M, greater than or equal to 0.2 M, greater than or equal to 0.5 M, greater than or equal to 1 M, or greater than or equal to 2 M. The electrolyte may comprise LiPF6 at a concentration of less than or equal to 5 M, less than or equal to 2 M, less than or equal to 1 M, less than or equal to 0.5 M, less than or equal to 0.2 M, less than or equal to 0.1 M, less than or equal to 0.05 M, or less than or equal to 0.02 M. Combinations of the above-referenced ranges are also possible (e.g., greater than or equal to 0.01 M and less than or equal to 5 M). Other ranges are also possible.

In some embodiments, an electrolyte comprises a species with an oxalato(borate) group (e.g., LiBOB, lithium difluoro(oxalato)borate), and the total weight of the species with an (oxalato)borate group in the electrolyte may be less than or equal to 30 wt %, less than or equal to 28 wt %, less than or equal to 25 wt %, less than or equal to 22 wt %, less than or equal to 20 wt %, less than or equal to 18 wt %, less than or equal to 15 wt %, less than or equal to 12 wt %, less than or equal to 10 wt %, less than or equal to 8 wt %, less than or equal to 6 wt %, less than or equal to 5 wt %, less than or equal to 4 wt %, less than or equal to 3 wt %, less than or equal to 2 wt %, or less than or equal to 1 wt % versus the total weight of the electrolyte. In some embodiments, the total weight of the species with an (oxalato)borate group in the electrochemical cell is greater than 0.2 wt %, greater than 0.5 wt %, greater than 1 wt %, greater than 2 wt %, greater than 3 wt %, greater than 4 wt %, greater than 6 wt %, greater than 8 wt %, greater than 10 wt %, greater than 15 wt %, greater 18 wt %, greater than 20 wt %, greater than 22 wt %, greater than 25 wt %, or greater than 28 wt % versus the total weight of the electrolyte. Combinations of the above-referenced ranges are also possible (e.g., greater than 0.2 wt % and less than or equal to 30 wt %, greater than 0.2 wt % and less than or equal to 20 wt %, greater than 0.5 wt % and less than or equal to 20 wt %, greater than 1 wt % and less than or equal to 8 wt %, greater than 1 wt % and less than or equal to 6 wt %, greater than 4 wt % and less than or equal to 10 wt %, greater than 6 wt % and less than or equal to 15 wt %, or greater than 8 wt % and less than or equal to 20 wt %). Other ranges are also possible.

In some embodiments, an electrolyte comprises fluoroethylene carbonate. In some embodiments, the total weight of the fluoroethylene carbonate in the electrolyte may be less than or equal to 30 wt %, less than or equal to 28 wt %, less than or equal to 25 wt %, less than or equal to 22 wt %, less than or equal to 20 wt %, less than or equal to 18 wt %, less than or equal to 15 wt %, less than or equal to 12 wt %, less than or equal to 10 wt %, less than or equal to 8 wt %, less than or equal to 6 wt %, less than or equal to 5 wt %, less than or equal to 4 wt %, less than or equal to 3 wt %, less than or equal to 2 wt %, or less than or equal to 1 wt % versus the total weight of the electrolyte. In some embodiments, the total weight of the fluoroethylene carbonate in the electrolyte is greater than 0.2 wt %, greater than 0.5 wt %, greater than 1 wt %, greater than 2 wt %, greater than 3 wt %, greater than 4 wt %, greater than 6 wt %, greater than 8 wt %, greater than 10 wt %, greater than 15 wt %, greater than 18 wt %, greater than 20 wt %, greater than 22 wt %, greater than 25 wt %, or greater than 28 wt % versus the total weight of the electrolyte. Combinations of the above-referenced ranges are also possible (e.g., less than or equal to 0.2 wt % and greater than 30 wt %, less than or equal to 15 wt % and greater than 20 wt %, or less than or equal to 20 wt % and greater than 25 wt %). Other ranges are also possible.

In some embodiments, the wt % of one or more electrolyte components is measured prior to first use or first discharge of the electrochemical cell using known amounts of the various components. In other embodiments, the wt % is measured at a point in time during the cycle life of the cell. In some such embodiments, the cycling of an electrochemical cell may be stopped and the wt % of the relevant component in the electrolyte may be determined using, for example, gas chromatography-mass spectrometry. Other methods such as NMR, inductively coupled plasma mass spectrometry (ICP-MS), and elemental analysis can also be used.

In some embodiments, an electrolyte may comprise several species together that are particularly beneficial in combination. For instance, in some embodiments, the electrolyte comprises fluoroethylene carbonate, dimethyl carbonate, and LiPF₆. The weight ratio of fluoroethylene carbonate to dimethyl carbonate may be between 20 wt %:80 wt % and 25 wt %:75 wt % and the concentration of LiPF₆ in the electrolyte may be approximately 1 M (e.g., between 0.05 M and 2 M). The electrolyte may further comprise lithium bis(oxalato)borate (e.g., at a concentration between 0.1 wt % and 6 wt %, between 0.5 wt % and 6 wt %, or between 1 wt % and 6 wt % in the electrolyte), and/or lithium tris(oxalato)phosphate (e.g., at a concentration between 1 wt % and 6 wt % in the electrolyte).

In some embodiments, the polymeric surfactant has high stability in the electrolyte (e.g., liquid electrolyte). For example, the polymeric surfactant retains its useful properties for the full timescale of its use in the electrolyte. In some embodiments, the polymeric surfactant does not react with the electrolyte.

In some embodiments, the polymeric surfactant has low solubility in the electrolyte (e.g., liquid electrolyte). For example, in some embodiments, the polymeric surfactant is less than or equal to 5 wt. %, less than or equal to 4 wt. %, less than or equal to 3 wt. %, less than or equal to 2 wt. %, or less than or equal to 1 wt. % soluble in the electrolyte. In some embodiments, the polymeric surfactant is greater than or equal to 0.001 wt. %, greater than or equal to 0.01 wt. %, or greater than or equal to 0.1 wt. % soluble in the electrolyte. Combinations of these ranges are also possible (e.g., greater than or equal to 0.001 wt. % and less than or equal to 5 wt. %). Solubility may be measured by saturating an amount of the electrolyte with the polymeric surfactant, weighing the saturated solution, evaporating the electrolyte, and weighing the solid left behind. The weight of the solid left behind compared to the weight of the saturated solution would be the solubility of the polymeric surfactant in wt. %. For example, if the saturated solution weighed 1,000 grams and the solid left behind weighed 1 gram, then the polymeric surfactant would have a solubility of 0.1 wt. % (1/1,000*100).

In some embodiments, the electrochemical cell comprises one or more electrodes (e.g., a cathode and/or an anode). For example, in FIG. 2C, in some embodiments, electrochemical cell 2000 comprises electrochemical cell component 700 (e.g., an electrode) and, optionally, other components (e.g., electrolyte 800, electrode 900, and/or layer 1000 disposed on and/or coating electrochemical cell component 700 (e.g., an electrode)).

In some embodiments, a first electrode comprises an anode and/or a negative electrode (e.g., an electrode at which oxidation occurs during discharging and reduction occurs during charging). In some embodiments, the first electrode comprises electroactive material. In some embodiments, the first electrode and/or the electroactive material comprises lithium (e.g., lithium metal and/or a lithium alloy). Suitable lithium alloys can include alloys of lithium and aluminum, magnesium, silicium (silicon), indium, and/or tin. In some embodiments, a first electrode comprises an electroactive material that contains at least 50 wt % lithium. In some cases, the electroactive material contains at least 75 wt %, at least 90 wt %, at least 95 wt %, or at least 99 wt % lithium.

The electroactive material in a first electrode may take the form of a foil (e.g., lithium foil), lithium deposited (e.g., vacuum deposited) onto a conductive substrate (e.g., lithium deposited onto a conductive substrate, such as a released Cu/PVOH substrate), or may have another suitable structure. In some embodiments, the electroactive material in the first electrode forms one film or several films, which are optionally separated from each other. In some embodiments, the first electrode and/or electroactive material comprises a lithium intercalation compound (e.g., a compound that is capable of reversibly inserting lithium ions at lattice sites and/or interstitial sites), such as a lithium carbon anode.

In some embodiments, a surface of the electroactive material of the first electrode may be passivated. Without wishing to be bound by theory, electroactive material surfaces that are passivated are surfaces that have undergone a chemical reaction to form a layer that is less reactive (e.g., with an electrolyte) than material that is present in the bulk of the electroactive material. One method of passivating an electroactive material surface is to expose the electroactive material to a plasma comprising CO₂ and/or SO₂ to form a CO₂- and/or SO₂-induced layer. Some inventive methods and articles may comprise passivating an electroactive material by exposing it to CO₂ and/or SO₂, or an electroactive material with a surface that has been passivated by exposure to CO₂ and/or SO₂. Such exposure may form a porous passivation layer on the electroactive material (e.g., a CO₂- and/or SO₂-induced layer).

In some embodiments, the polymeric surfactant does not react with the electrode and/or electroactive material (e.g., lithium metal).

In some embodiments, an electrode (e.g., a second electrode) comprises a cathode and/or a positive electrode (e.g., an electrode at which reduction occurs during discharging and oxidation occurs during charging). In some embodiments, the second electrode comprises electroactive material. A second electrode may comprise an electroactive material comprising a lithium intercalation compound (e.g., a compound that is capable of reversibly inserting lithium ions at lattice sites and/or interstitial sites). In some cases, the electroactive material comprises a lithium transition metal oxo compound (i.e., a lithium transition metal oxide or a lithium transition metal salt of an oxoacid). The electroactive material may be a layered oxide (e.g., a layered oxide that is also a lithium transition metal oxo compound). A layered oxide generally refers to an oxide having a lamellar structure (e.g., a plurality of sheets, or layers, stacked upon each other). Non-limiting examples of suitable layered oxides (e.g., lithium transition metal oxides) include lithium nickel manganese cobalt oxide, lithium nickel cobalt aluminum oxide, lithium cobalt oxide (LiCoO₂), lithium nickel oxide (LiNiO₂), and lithium manganese oxide (LiMnO₂).

In some embodiments, a second electrode comprises a layered oxide that is lithium nickel manganese cobalt oxide (LiNiₓMn_{y}Co_{z}O₂, also referred to as “NMC” or “NCM,” such as NCM622, NCM721, and/or NCM811). In some such embodiments, the sum of x, y, and z is 1. For example, a non-limiting example of a suitable NMC compound is LiNi_{1/3}Mn_{1/3}Co_{1/3}O₂. Other non-limiting examples of suitable NMC compounds include LiNi_{3/5}Mn_{1/5}Co_{1/5}O₂ and LiNi_{7/10}Mn_{1/10}Co_{1/5}O₂.

In some embodiments, a second electrode comprises a layered oxide that is lithium nickel cobalt aluminum oxide (LiNiₓCo_{y}Al_{z}O₂, also referred to as “NCA”). In some such embodiments, the sum of x, y, and z is 1. For example, a non-limiting example of a suitable NCA compound is LiNi_{0.8}Co_{0.15}Al_{0.05}O₂.

In some embodiments, the second electrode and/or the electroactive material comprises a transition metal. In some embodiments, the transition metal comprises Co, Ni, Mn, Fe, Cr, V, Cu, Zr, Nb, Mo, Ag, and/or lanthanide metals. In some embodiments, the transition metal comprises a transition metal oxide (e.g., a lithium transition metal oxide, as discussed above). For example, in some embodiments, the second electrode and/or the electroactive material comprises a transition metal polyanion oxide (e.g., a compound comprising a transition metal, an oxygen, and/or an anion having a charge with an absolute value greater than 1). A non-limiting example of a suitable transition metal polyanion oxide is lithium iron phosphate (LiFePO₄, also referred to as “LFP”). Another non-limiting example of a suitable transition metal polyanion oxide is lithium manganese iron phosphate (LiMnₓFe₁₋ₓPO₄, also referred to as “LMFP”). A non-limiting example of a suitable LMFP compound is LiMn_{0.8}Fe_{0.2}PO₄.

In some embodiments, the electroactive material comprises a spinel (e.g., a compound having the structure AB₂O₄, where A can be Li, Mg, Fe, Mn, Zn, Cu, Ni, Ti, or Si, and B can be Al, Fe, Cr, Mn, or V). A non-limiting example of a suitable spinel is lithium manganese oxide (LiMn₂O₄, also referred to as “LMO”). Another non-limiting example is lithium manganese nickel oxide (LiNiₓM₂₋ₓO₄, also referred to as “LMNO”). A non-limiting example of a suitable LMNO compound is LiNi_{0.5}Mn_{1.5}O₄. In some cases, the electroactive material comprises Li_{1.14}Mn_{0.42}Ni_{0.25}Co_{0.29}O₂ (“HC-MNC”), lithium carbonate (Li₂CO₃), lithium carbides (e.g., Li₂C₂, Li₄C, Li₆C₂, Li₈C₃, Li₆C₃, Li₄C₃, Li₄C₅), vanadium oxides (e.g., V₂O₅, V₂O₃, V₆O₁₃), and/or vanadium phosphates (e.g., lithium vanadium phosphates, such as Li₃V₂(PO₄)₃), or any combination thereof.

In some embodiments, the electroactive material in a second electrode comprises a conversion compound. For instance, the electroactive material may be a lithium conversion material. It has been recognized that a cathode comprising a conversion compound may have a relatively large specific capacity. Without wishing to be bound by a particular theory, a relatively large specific capacity may be achieved by utilizing all possible oxidation states of a compound through a conversion reaction in which more than one electron transfer takes place per transition metal (e.g., compared to 0.1-1 electron transfer in intercalation compounds). Suitable conversion compounds include, but are not limited to, transition metal oxides (e.g., Co₃O₄), transition metal hydrides, transition metal sulfides, transition metal nitrides, and transition metal fluorides (e.g., CuF₂, FeF₂, FeF₃). A transition metal generally refers to an element whose atom has a partially filled d sub-shell (e.g., Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Jr, Pt, Au, Hg, Rf, Db, Sg, Bh, Hs). In some cases, the electroactive material may comprise a material that is doped with one or more dopants to alter the electrical properties (e.g., electrical conductivity) of the electroactive material. Non-limiting examples of suitable dopants include aluminum, niobium, silver, and zirconium.

In some embodiments, the electroactive material in a second electrode can comprise sulfur. In some embodiments, an electrode that is a cathode can comprise electroactive sulfur-containing materials. “Electroactive sulfur-containing materials,” as used herein, refers to electroactive materials which comprise the element sulfur in any form, wherein the electrochemical activity involves the oxidation or reduction of sulfur atoms or moieties. As an example, the electroactive sulfur-containing material may comprise elemental sulfur (e.g., S₈). In some embodiments, the electroactive sulfur-containing material comprises a mixture of elemental sulfur and a sulfur-containing polymer. Thus, suitable electroactive sulfur-containing materials may include, but are not limited to, elemental sulfur, sulfides or polysulfides (e.g., of alkali metals) which may be organic or inorganic, and organic materials comprising sulfur atoms and carbon atoms, which may or may not be polymeric. Suitable organic materials include, but are not limited to, those further comprising heteroatoms, conductive polymer segments, composites, and conductive polymers. In some embodiments, an electroactive sulfur-containing material within a second electrode (e.g., a cathode) comprises at least 40 wt % sulfur. In some cases, the electroactive sulfur-containing material comprises at least 50 wt %, at least 75 wt %, or at least 90 wt % sulfur.

Examples of sulfur-containing polymers include those described in: U.S. Pat. Nos. 5,601,947 and 5,690,702 to Skotheim et al.; U.S. Pat. Nos. 5,529,860 and 6,117,590 to Skotheim et al.; U.S. Pat. No. 6,201,100 issued Mar. 13, 2001, to Gorkovenko et al., and PCT Publication No. WO 99/33130, which are incorporated herein by reference in their entirety and for all purposes. Other suitable electroactive sulfur-containing materials comprising polysulfide linkages are described in U.S. Pat. No. 5,441,831 to Skotheim et al.; U.S. Pat. No. 4,664,991 to Perichaud et al., and in U.S. Pat. Nos. 5,723,230, 5,783,330, 5,792,575 and 5,882,819 to Naoi et al., which are incorporated herein by reference in their entirety and for all purposes. Still further examples of electroactive sulfur-containing materials include those comprising disulfide groups as described, for example in, U.S. Pat. No. 4,739,018 to Armand et al.; U.S. Pat. Nos. 4,833,048 and 4,917,974, both to De Jonghe et al.; U.S. Pat. Nos. 5,162,175 and 5,516,598, both to Visco et al.; and U.S. Pat. No. 5,324,599 to Oyama et al., which are incorporated herein by reference in their entirety and for all purposes.

In some embodiments, the second electrode and/or electroactive material comprises a combination of any of the electroactive materials described for the second electrode (e.g., NCM811 and NCM721).

In some embodiments, the second electrode comprises an NCM811 cathode, an intercalation cathode, a Li-metal oxide intercalation cathode as NCM or LCO, and/or a Li-metal phosphate intercalation cathode as LFP or LiMnPO₄.

In some embodiments, the electrochemical cell comprises a separator. For example, in FIG. 2C, in some embodiments, electrochemical cell 2000 comprises electrochemical cell component 700 (e.g., a separator) and, optionally, other components (e.g., electrolyte 800, electrode 900, and/or layer 1000 disposed on and/or coating electrochemical cell component 700 (e.g., a separator)).

In some embodiments, the separator comprises a polymeric material (e.g., polymeric material that does or does not swell upon exposure to electrolyte) (e.g., monolayer or multilayer), glass, ceramic, and/or combinations thereof (e.g., ceramic/polymer composite or ceramic coated polymer). In some embodiments, the separator is located between an electrolyte and an electrode (e.g., between the electrolyte and a first electrode, between the electrolyte and a second electrode) and/or between two electrodes (e.g., between a first electrode and a second electrode).

The separator can be configured to inhibit (e.g., prevent) physical contact between two electrodes (e.g., between a first electrode and a second electrode), which could result in short circuiting of the electrochemical cell. The separator can be configured to be substantially electronically non-conductive, which can reduce the tendency of electric current to flow therethrough and thus reduce the possibility that a short circuit passes therethrough. In some embodiments, all or one or more portions of the separator can be formed of a material with a bulk electronic resistivity of at least 10⁴, at least 10⁵, at least 10¹⁰, at least 10¹⁵, or at least 10²⁰ Ohm-meters. The bulk electronic resistivity may be measured at room temperature (e.g., 25° C.).

In some embodiments, the separator can be ionically conductive, while in other embodiments, the separator is substantially ionically non-conductive. In some embodiments, the average ionic conductivity of the separator is at least 10⁻⁷ S/cm, at least 10⁻⁶ S/cm, at least 10⁻⁵ S/cm, at least 10⁻⁴ S/cm, at least 10⁻² S/cm, or at least 10⁻¹ S/cm. In some embodiments, the average ionic conductivity of the separator may be less than or equal to 1 S/cm, less than or equal to 10⁻¹ S/cm, less than or equal to 10⁻² S/cm, less than or equal to 10⁻³ S/cm, less than or equal to 10⁻⁴ S/cm, less than or equal to 10⁻⁵ S/cm, less than or equal to 10⁻⁶ S/cm, less than or equal to 10⁻⁷ S/cm, or less than or equal to 10⁻⁸ S/cm. Combinations of the above—referenced ranges are also possible (e.g., an average ionic conductivity of at least 10⁻⁸ S/cm and less than or equal to 10⁻¹ S/cm). Other values of ionic conductivity are also possible.

The average ionic conductivity of the separator can be determined by employing a conductivity bridge (i.e., an impedance measuring circuit) to measure the average resistivity of the separator at a series of increasing pressures until the average resistivity of the separator does not change as the pressure is increased. This value is considered to be the average resistivity of the separator, and its inverse is considered to be the average conductivity of the separator. The conductivity bridge may be operated at 1 kHz. The pressure may be applied to the separator in 500 kg/cm² increments by two copper cylinders positioned on opposite sides of the separator that are capable of applying a pressure to the separator of at least 3 tons/cm². The average ionic conductivity may be measured at room temperature (e.g., 25° C.).

In some embodiments, the separator can be a solid. The separator may be sufficiently porous such that it allows an electrolyte solvent to pass through it. In some embodiments, the separator does not substantially include a solvent (e.g., it may be unlike a gel that comprises solvent throughout its bulk), except for solvent that may pass through or reside in the pores of the separator. In other embodiments, a separator may be in the form of a gel.

A separator can comprise a variety of materials. The separator may comprise one or more polymers (e.g., the separator may be polymeric, the separator may be formed of one or more polymers), and/or may comprise an inorganic material (e.g., the separator may be inorganic, the separator may be formed of one or more inorganic materials).

Examples of suitable polymers that may be employed in separators include, but are not limited to, polyolefins (e.g., polyethylenes, poly(butene-1), poly(n-pentene-2), polypropylene, polytetrafluoroethylene); polyamines (e.g., poly(ethylene imine) and polypropylene imine (PPI)); polyamides (e.g., polyamide (Nylon), poly(ϵ-caprolactam) (Nylon 6), poly(hexamethylene adipamide) (Nylon 66)); polyimides (e.g., polyimide, polynitrile, and poly(pyromellitimide-1,4-diphenyl ether) (Kapton®) (NOMEX®) (KEVLAR®)); polyether ether ketone (PEEK); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly(vinyl alcohol), poly(vinyl chloride), poly(vinyl fluoride), poly(2-vinyl pyridine), vinyl polymer, polychlorotrifluoro ethylene, and poly(isohexylcyanoacrylate)); polyacetals; polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some embodiments, the polymer may be selected from poly(n-pentene-2), polypropylene, polytetrafluoroethylene, polyamides (e.g., polyamide (Nylon), poly(ϵ-caprolactam) (Nylon 6), poly(hexamethylene adipamide) (Nylon 66)), polyimides (e.g., polynitrile, and poly(pyromellitimide-1,4-diphenyl ether) (Kapton®) (NOMEX®) (KEVLAR®)), polyether ether ketone (PEEK), and combinations thereof.

Non-limiting examples of suitable inorganic separator materials include glass fibers. For instance, in some embodiments, an electrochemical cell comprises a separator that is a glass fiber filter paper.

When present, the separator may be porous. In some embodiments, the pore size of the separator is less than or equal to 5 microns, less than or equal to 3 microns, less than or equal to 1 micron, less than or equal to 500 nm, less than or equal to 300 nm, less than or equal to 100 nm, or less than or equal to 50 nm. In some embodiments, the pore size of the separator is greater than or equal to 50 nm, greater than or equal to 100 nm, greater than or equal to 300 nm, greater than or equal to 500 nm, greater than or equal to 1 micron, or greater than or equal to 3 microns. Other values are also possible. Combinations of the above-noted ranges are also possible (e.g., less than or equal to 5 microns and greater than or equal to 50 nm, less than or equal to 300 nm and greater than or equal to 100 nm, less than or equal to 1 micron and greater than or equal to 300 nm, or less than or equal to 5 microns and greater than or equal to 500 nm).

In some embodiments, the separator is substantially non-porous. In other words, in some embodiments, the separator may lack pores, include a minimal number of pores, and/or not include pores in large portions thereof.

When present, the separator may be porous. In some embodiments, the pore size of the separator is less than or equal to 5 microns, less than or equal to 3 microns, less than or equal to 1 micron, less than or equal to 500 nm, less than or equal to 300 nm, less than or equal to 100 nm, or less than or equal to 50 nm. In some embodiments, the pore size of the separator is greater than or equal to 50 nm, greater than or equal to 100 nm, greater than or equal to 300 nm, greater than or equal to 500 nm, greater than or equal to 1 micron, or greater than or equal to 3 microns. Other values are also possible. Combinations of the above-noted ranges are also possible (e.g., less than or equal to 5 microns and greater than or equal to 50 nm, less than or equal to 300 nm and greater than or equal to 100 nm, less than or equal to 1 micron and greater than or equal to 300 nm, or less than or equal to 5 microns and greater than or equal to 500 nm).

In some embodiments, the separator is substantially non-porous. In other words, in some embodiments, the separator may lack pores, include a minimal number of pores, and/or not include pores in large portions thereof.

In some embodiments, the separator is porous. In some embodiments, the separator comprises a polyolefin, a porous ceramic, a porous glass, and/or a porous polymer.

In some embodiments, an electrochemical cell described herein comprises at least one current collector. A current collector may be disposed on an electrode (e.g., a first electrode, a second electrode), and may provide electrons from the electrode to an external circuit (e.g., in the case of a current collector disposed on an anode or negative electrode) or may supply electrons to the electrode from an external circuit (e.g., in the case of a current collector disposed on a cathode or positive electrode). Non-limiting examples of suitable materials that may be employed in current collectors include metals (e.g., copper, nickel, aluminum, passivated metals), metallized polymers (e.g., metallized PET), electrically conductive polymers, and polymers comprising conductive particles dispersed therein.

Current collectors may be formed in a variety of manners. For instance, a current collector may be deposited onto an electrode by physical vapor deposition, chemical vapor deposition, electrochemical deposition, sputtering, doctor blading, flash evaporation, or any other appropriate deposition technique for the selected material. As another example, in some embodiments, a current collector is formed separately from an electrode and then bonded to the electrode (and/or to a component, such as a layer, thereof). It should be appreciated, however, that in some embodiments a current collector separate from an electrode (e.g., separate from a first electrode, separate from a second electrode) is not needed or present. This may be true when the electrode itself (and/or the electroactive material therein) is electrically conductive.

It can be advantageous, according to some embodiments, to apply an anisotropic force to the electrochemical cells described herein during charge and/or discharge. In some embodiments, the electrochemical cells and/or the electrodes described herein can be configured to withstand an applied anisotropic force (e.g., a force applied to enhance the morphology of an electrode within the cell) while maintaining their structural integrity.

In some embodiments, any of the electrodes described herein can be part of an electrochemical cell that is constructed and arranged such that, during at least one period of time during charge and/or discharge of the cell, an anisotropic force with a component normal to the active surface of an electrode within the electrochemical cell (e.g., an electrode comprising lithium metal and/or a lithium alloy, such as an anode comprising lithium metal and/or a lithium alloy) is applied to the cell. In some embodiments, any of the protective layers and/or SEIs described herein can be part of an electrochemical cell that is constructed and arranged such that, during at least one period of time during charge and/or discharge of the cell, an anisotropic force with a component normal to the active surface of an electrode within the electrochemical cell (e.g., an electrode comprising lithium metal and/or a lithium alloy, such as an anode comprising lithium metal and/or a lithium alloy) is applied to the cell. In one set of embodiments, the applied anisotropic force can be selected to enhance the morphology of an electrode (e.g., an electrode comprising lithium metal and/or a lithium alloy, such as a lithium metal and/or a lithium alloy anode).

An “anisotropic force” is given its ordinary meaning in the art and means a force that is not equal in all directions. A force equal in all directions is, for example, internal pressure of a fluid or material within the fluid or material, such as internal gas pressure of an object. Examples of forces not equal in all directions include forces directed in a particular direction, such as the force on a table applied by an object on the table via gravity. Another example of an anisotropic force includes a force applied by a band arranged around a perimeter of an object. For example, a rubber band or turnbuckle can apply forces around a perimeter of an object around which it is wrapped. However, the band may not apply any direct force on any part of the exterior surface of the object not in contact with the band. In addition, when the band is expanded along a first axis to a greater extent than a second axis, the band can apply a larger force in the direction parallel to the first axis than the force applied parallel to the second axis.

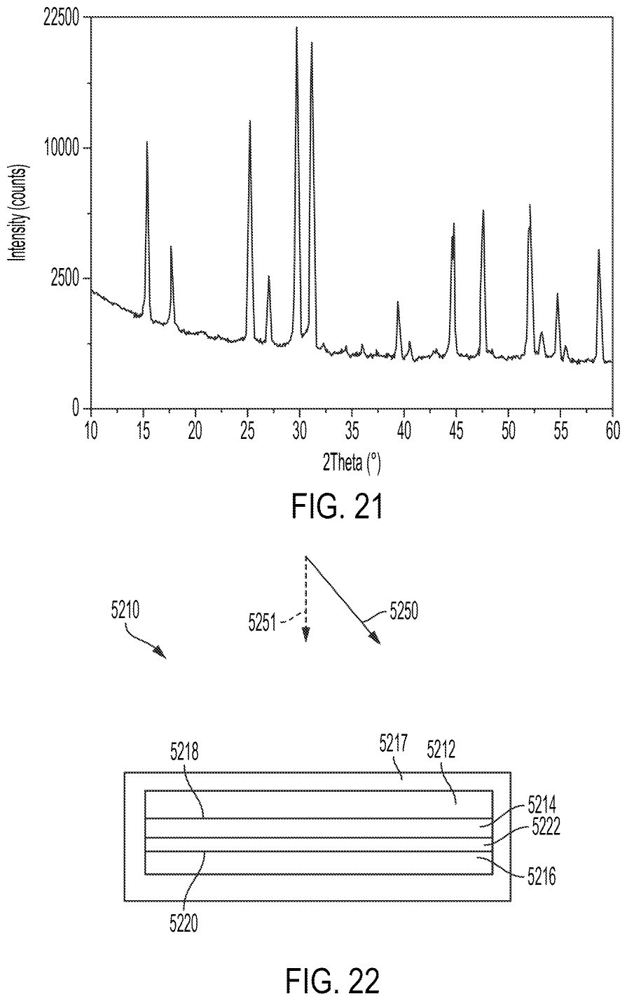

In some such cases, the anisotropic force comprises a component normal to an active surface of an electrode within an electrochemical cell. As used herein, the term “active surface” is used to describe a surface of an electrode at which electrochemical reactions may take place. For example, referring to FIG. 22, an electrochemical cell 5210 can comprise a second electrode 5212 which can include an active surface 5218 and/or a first electrode 5216 which can include an active surface 5220. The electrochemical cell 5210 further comprises an electrolyte 5214 and a protective layer 5222. In some embodiments, an electrochemical cell to which an anisotropic force is applied comprises an SEI (e.g., in addition to, instead of, or as a component of a protective layer). In FIG. 22, a component 5251 of an anisotropic force 5250 is normal to both the active surface of the second electrode and the active surface of the first electrode. In some embodiments, the anisotropic force comprises a component normal to a surface of a protective layer in contact with an electrolyte.

A force with a “component normal” to a surface is given its ordinary meaning as would be understood by those of ordinary skill in the art and includes, for example, a force which at least in part exerts itself in a direction substantially perpendicular to the surface. For example, in the case of a horizontal table with an object resting on the table and affected only by gravity, the object exerts a force essentially completely normal to the surface of the table. If the object is also urged laterally across the horizontal table surface, then it exerts a force on the table which, while not completely perpendicular to the horizontal surface, includes a component normal to the table surface. Those of ordinary skill can understand other examples of these terms, especially as applied within the description of this document. In the case of a curved surface (for example, a concave surface or a convex surface), the component of the anisotropic force that is normal to an active surface of an electrode may correspond to the component normal to a plane that is tangent to the curved surface at the point at which the anisotropic force is applied. The anisotropic force may be applied, in some cases, at one or more pre-determined locations, optionally distributed over the active surface of the electrode and/or over a surface of a protective layer. In some embodiments, the anisotropic force is applied uniformly over the active surface of the first electrode (e.g., of the anode) and/or uniformly over a surface of a protective layer in contact with an electrolyte.

Any of the electrochemical cell properties and/or performance metrics described herein may be achieved, alone or in combination with each other, while an anisotropic force is applied to the electrochemical cell (e.g., during charge and/or discharge of the cell) during charge and/or discharge. In some embodiments, the anisotropic force applied to the electrode and/or to the electrochemical cell (e.g., during at least one period of time during charge and/or discharge of the cell) can include a component normal to an active surface of an electrode (e.g., an anode such as a lithium metal and/or lithium alloy anode within the electrochemical cell). In some embodiments, the component of the anisotropic force that is normal to the active surface of the electrode defines a pressure of greater than or equal to 1 kg/cm², greater than or equal to 2 kg/cm², greater than or equal to 4 kg/cm², greater than or equal to 6 kg/cm², greater than or equal to 8 kg/cm², greater than or equal to 10 kg/cm², greater than or equal to 12 kg/cm², greater than or equal to 14 kg/cm², greater than or equal to 16 kg/cm², greater than or equal to 18 kg/cm², greater than or equal to 20 kg/cm², greater than or equal to 22 kg/cm², greater than or equal to 24 kg/cm², greater than or equal to 26 kg/cm², greater than or equal to 28 kg/cm², greater than or equal to 30 kg/cm², greater than or equal to 32 kg/cm², greater than or equal to 34 kg/cm², greater than or equal to 36 kg/cm², greater than or equal to 38 kg/cm², greater than or equal to 40 kg/cm², greater than or equal to 42 kg/cm², greater than or equal to 44 kg/cm², greater than or equal to 46 kg/cm², or greater than or equal to 48 kg/cm². In some embodiments, the component of the anisotropic force normal to the active surface may, for example, define a pressure of less than or equal to 50 kg/cm², less than or equal to 48 kg/cm², less than or equal to 46 kg/cm², less than or equal to 44 kg/cm², less than or equal to 42 kg/cm², less than or equal to 40 kg/cm², less than or equal to 38 kg/cm², less than or equal to 36 kg/cm², less than or equal to 34 kg/cm², less than or equal to 32 kg/cm², less than or equal to 30 kg/cm², less than or equal to 28 kg/cm², less than or equal to 26 kg/cm², less than or equal to 24 kg/cm², less than or equal to 22 kg/cm², less than or equal to 20 kg/cm², less than or equal to 18 kg/cm², less or equal to 16 kg/cm², less than or equal to 14 kg/cm², less than or equal to 12 kg/cm², less than or equal to 10 kg/cm², less than or equal to 8 kg/cm², less than or equal to 6 kg/cm², less than or equal to 4 kg/cm², or less than or equal to 2 kg/cm². Combinations of the above-referenced ranges are also possible (e.g., greater than or equal to 1 kg/cm² and less than or equal to 50 kg/cm², greater than or equal to 1 kg/cm² and less than or equal to 40 kg/cm², greater than or equal to 1 kg/cm² and less than or equal to 30 kg/cm², greater than or equal to 1 kg/cm² and less than or equal to 20 kg/cm², or greater than or equal to 10 kg/cm² and less than or equal to 20 kg/cm²). Other ranges are also possible.

In some embodiments, the component of the anisotropic force normal to the anode active surface is between about 20% and about 200% of the yield stress of the anode material (e.g., lithium metal), between about 50% and about 120% of the yield stress of the anode material, or between about 80% and about 100% of the yield stress of the anode material.

The anisotropic forces applied during charge and/or discharge as described herein may be applied using any method known in the art. In some embodiments, the force may be applied using compression springs. Forces may be applied using other elements (either inside or outside a containment structure) including, but not limited to Belleville washers, machine screws, pneumatic devices, and/or weights, among others. In some cases, cells may be pre-compressed before they are inserted into containment structures, and, upon being inserted to the containment structure, they may expand to produce a net force on the cell. Suitable methods for applying such forces are described in detail, for example, in U.S. Pat. No. 9,105,938, which is incorporated herein by reference in its entirety.

In some embodiments, the mixtures, layers, methods, and/or electrochemical cells disclosed herein have advantages, such as increased uniformity of a layer and/or increased cycle life. For example, in some embodiments, an electrochemical cell comprising a layer described herein has an increased cycle life compared to an electrochemical cell without the layer, all other factors being equal. In some embodiments, an electrochemical cell comprising a layer described herein (e.g., disposed on an electrochemical cell component, such as an electrode and/or a separator) has greater than or equal to 105%, greater than or equal to 110%, greater than or equal to 115%, greater than or equal to 120%, greater than or equal to 125%, greater than or equal to 130%, greater than or equal to 140%, greater than or equal to 150%, greater than or equal to 175%, or greater than or equal to 200% the cycle life of an electrochemical cell without the layer, all other factors being equal. In some embodiments, an electrochemical cell comprising a layer described herein has a cycle life of less than or equal to 500%, less than or equal to 400%, less than or equal to 300%, less than or equal to 250%, less than or equal to 200%, less than or equal to 175%, or less than or equal to 150% the cycle life of an electrochemical cell without the layer, all other factors being equal. Combinations of these ranges are also possible (e.g., greater than or equal to 105% and less than or equal to 500% or greater than or equal to 105% and less than or equal to 150%). For example, if an electrochemical cell comprising a layer described herein had a cycle life of 100 cycles and an electrochemical cell without the layer, all other factors being equal, had a cycle life of 80 cycles, then the former would have a cycle life of 125% (100/80*100) the cycle life of the latter.

The following examples are intended to illustrate certain embodiments of the present invention, but do not exemplify the full scope of the invention.

### EXAMPLES

### Examples 1-12 and Comparator Examples 1-2

This Example describes ball milling of ceramic particles with and without various polymeric surfactants. This Example demonstrates that milling with polymeric surfactants resulted in a decrease in particle size (i.e., diameter) and a decrease in particle size (i.e., diameter) distribution compared to milling without polymeric surfactants.

In Examples 1-12 and Comparator Examples 1-2, a raw sulfide solid electrolyte powder (Li₂₂SiP₂S₁₈) was mechanically milled using a high energy planetary ball mill (Planetary Micro Mill, Pulverisette 7 premium line, Fritsch). Each milling jar (80-mL of total volume) was filled with the following contents: raw powder of sulfide solid electrolyte (Li₂₂SiP₂S₁₈), optionally a polymeric surfactant (the total weight of raw powder and polymeric surfactant was 10 g), 100 g of 2-mm ZrO₂ beads, and 25 mL anhydrous heptane. Each milling cycle consisted of 5 minutes on at 500 rpm and 15 minutes off (for cooling off). Six cycles in total were carried out for each example. After the ball-milling, the mixture of powder and beads were dried in a vacuum oven at 120° C. for 2 hours, and then the beads were separated from the powder by sieving through a No. 80 testing sieve. The milled powder was characterized with powder conductivity, particle size analysis, and x-ray diffraction (XRD).

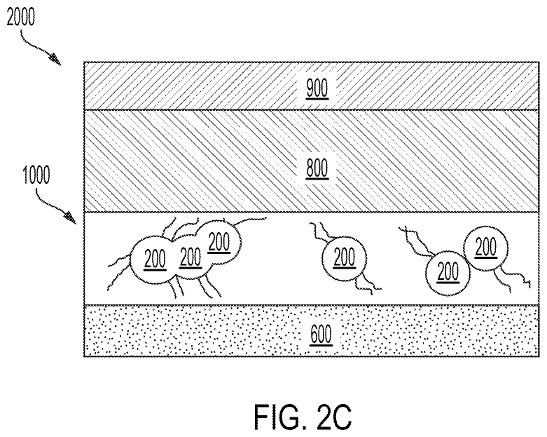

Comparator Example 1 was milled without a polymeric surfactant. As shown in FIG. 3, the median particle size was 9.6 microns with a wide distribution.

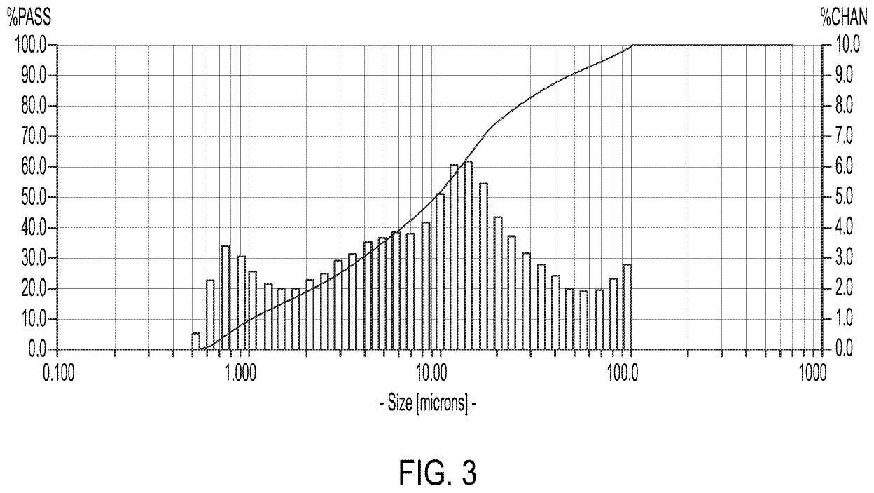

Comparator Example 2 was milled without a polymeric surfactant. Comparator Example 2 used twice as much ZrO₂ beads by weight relative to raw powder than Comparator Example 1. As shown in FIG. 4, the median particle size was 8.6 microns with a wide distribution.

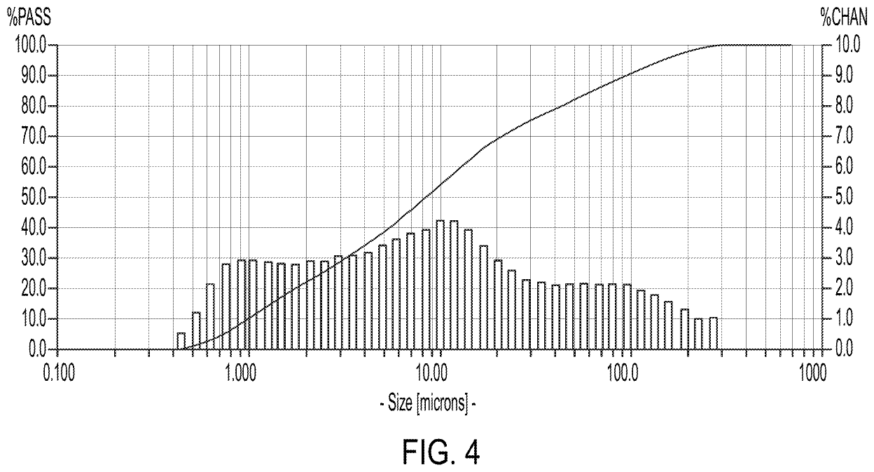

Example 1 was milled with 1 wt. % Triton X-100 (TX1568-1 from EMD (500 mL size) as the polymeric surfactant. As shown in FIG. 5, the median particle size was 2.1 microns with a narrow distribution. The conductivity of the milled powder was 5.3×10⁻⁴ S/cm.

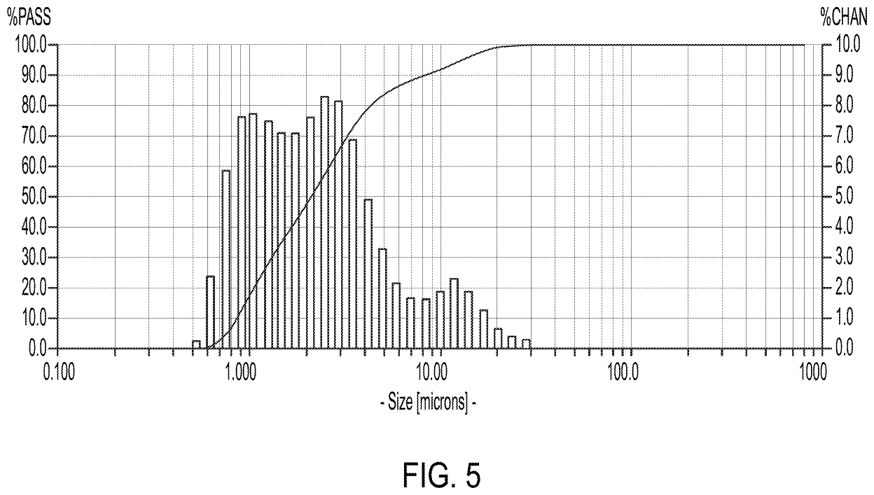

Example 2 was milled with 2 wt. % Triton X-100 as the polymeric surfactant. As shown in FIG. 6, the median particle size was 1.7 microns. The conductivity of the milled powder was 8.3×10⁻⁵ S/cm.

The Triton X-100 (TX-100) used in these examples was purchased from EMD (TX1568-1, 500 mL size, lot # 44099514) and had a molecular formula of C₃₄H₆₂O₁₁, a molecular weight of 646.86 g/mol, and the following structure:

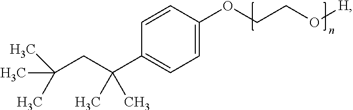

where n is 10.

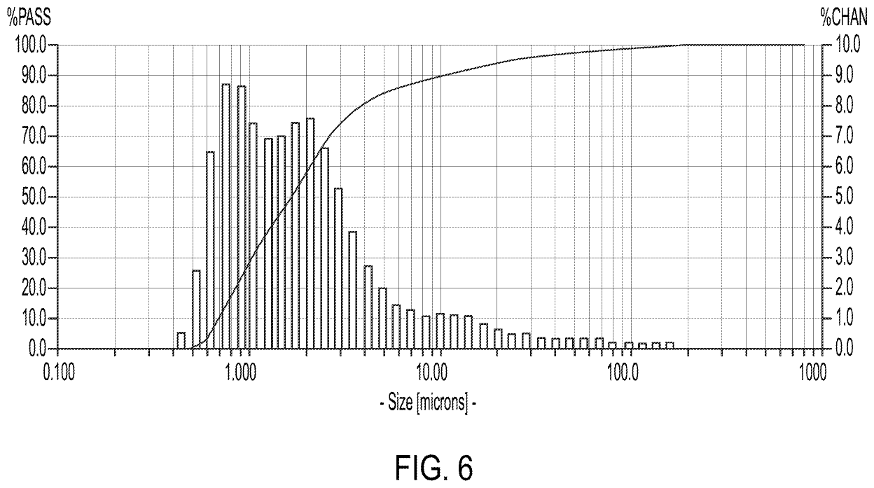

Example 3 was milled with 2.5 wt. % PEG400 (i.e., polyethylene glycol with a molecular weight of approximately 400 g/mol). As shown in FIG. 7, the median particle size was 2.0 microns with a narrow distribution.

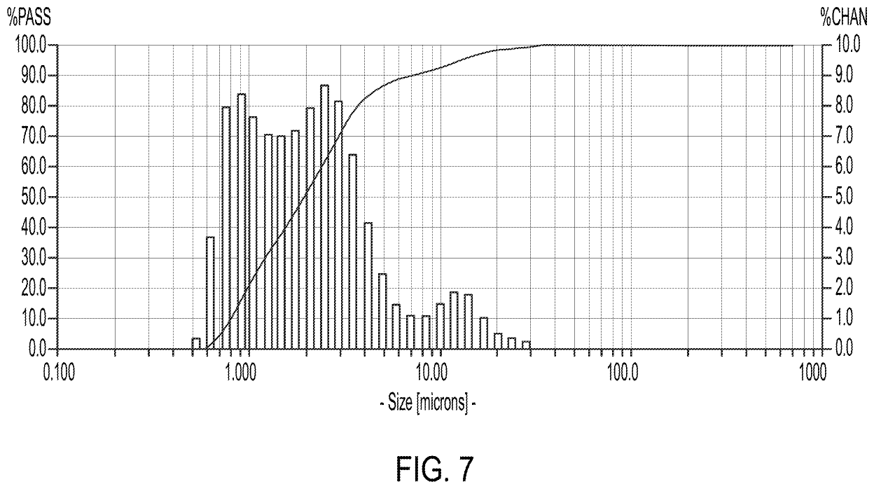

Example 4 was milled with 5 wt. % PEG400. As shown in FIG. 8, the median particle size was 1.5 microns with a narrow distribution.

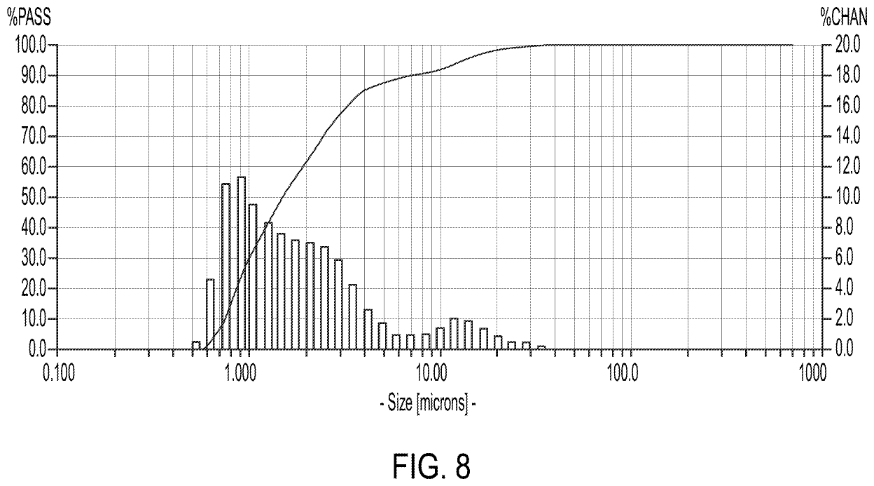

Example 5 was milled with 5 wt. % PVP40 (i.e., polyvinylpyrrolidone with a molecular weight of approximately 40,000 g/mol). As shown in FIG. 9, the median particle size was 3.7 microns with a narrow distribution.

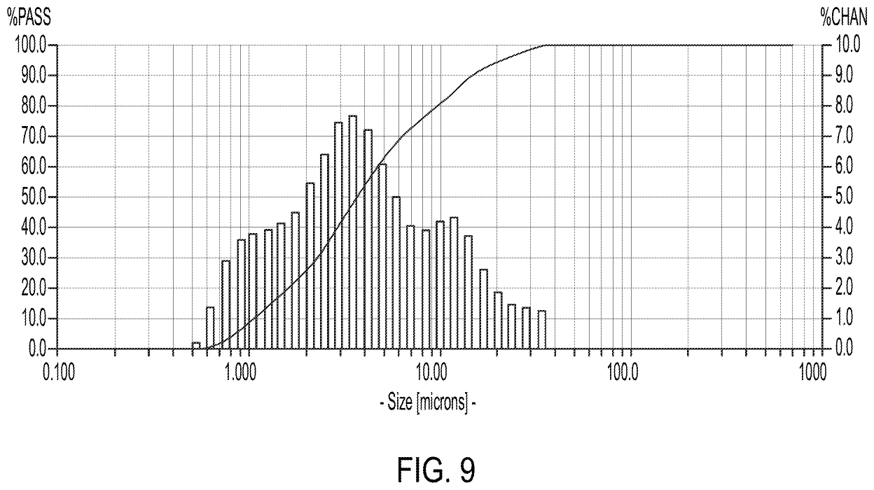

Example 6 was milled with 10 wt. % PVP40. As shown in FIG. 10, the median particle size was 1.2 microns with a narrow distribution. The conductivity of the milled powder was 1.3×10⁻⁴ S/cm.

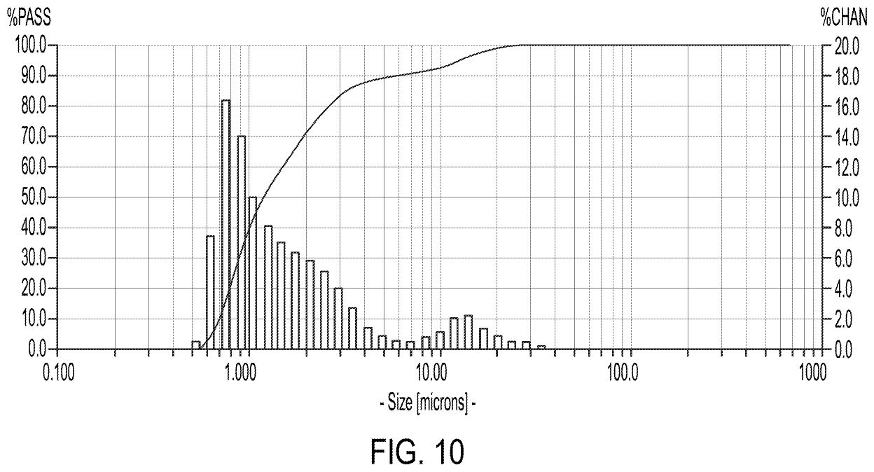

Example 7 was milled with 15 wt. % PVP40. As shown in FIG. 11, the median particle size was 1.2 microns with a narrow distribution.

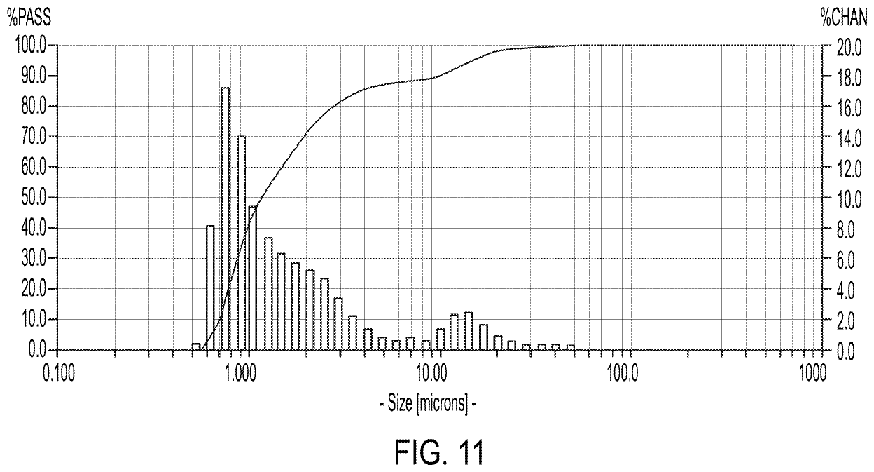

Example 8 was milled with 20 wt. % PVP40. As shown in FIG. 12, the median particle size was 1.2 microns with a narrow distribution.

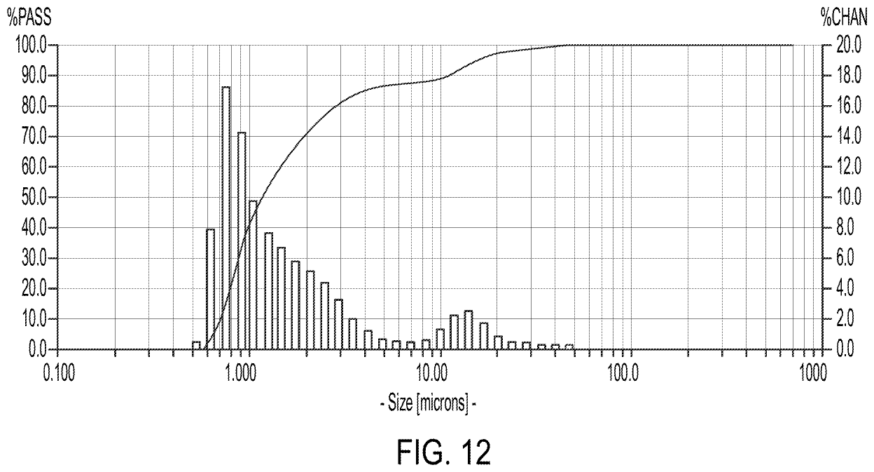

Example 9 was milled with 5 wt. % PVP8 (i.e., polyvinylpyrrolidone with a molecular weight of approximately 8,000 g/mol). As shown in FIG. 13, the median particle size was 1.5 microns with a narrow distribution.

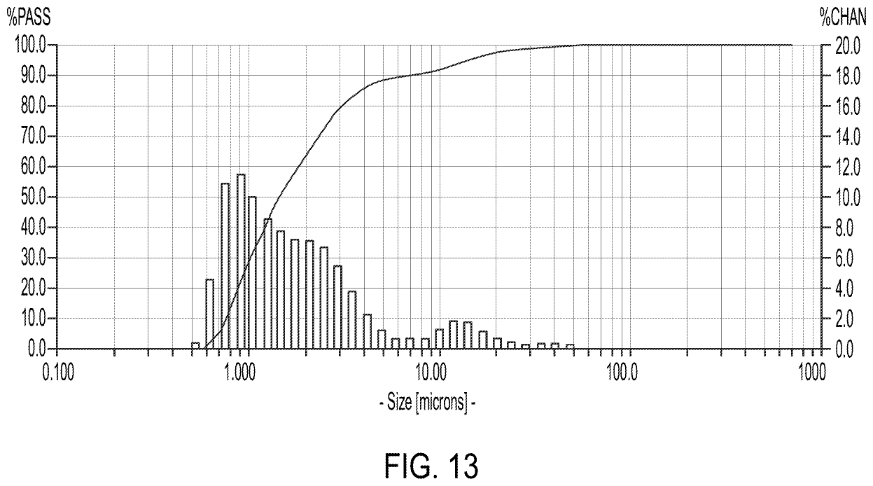

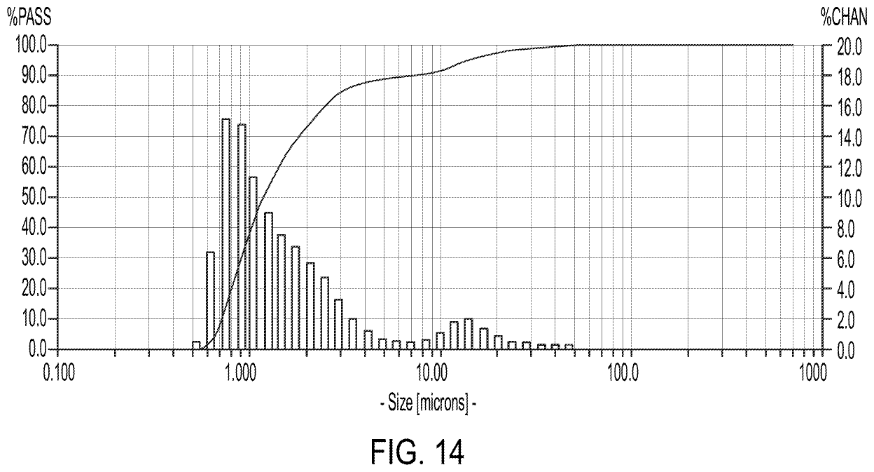

Example 10 was milled with 10 wt. % PVP8. As shown in FIG. 14, the median particle size was 1.2 microns with a narrow distribution. The conductivity of the milled powder was 5.9×10⁻⁵ S/cm. An XRD pattern of the milled powder is shown in FIG. 15. XRD peaks were assigned to the lithium argyrodite (Li₇PS₆) phase.

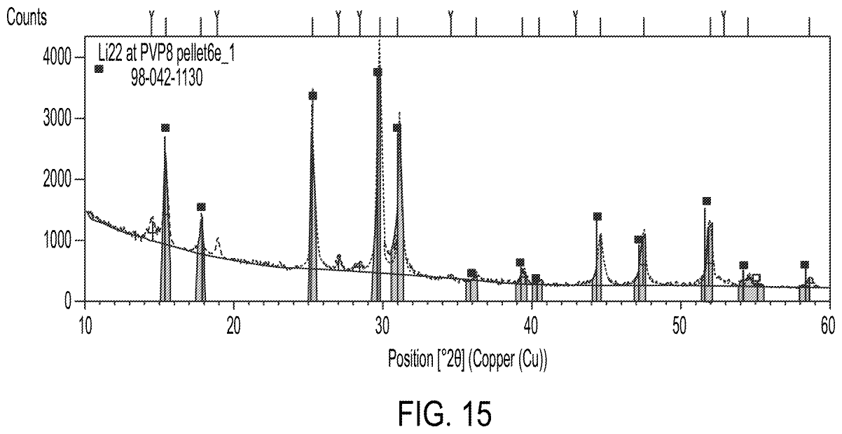

Example 11 was milled with 15 wt. % PVP8. As shown in FIG. 16, the median particle size was 1.2 microns.

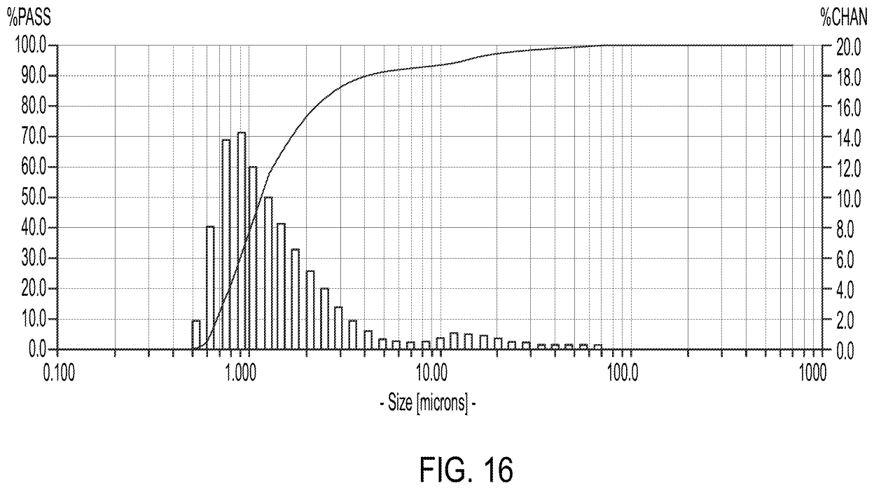

Example 12 was milled with 20 wt. % PVP8. As shown in FIG. 17, the median particle size was 1.1 microns.

The results of the milled powder of Comparator Examples 1-2 and Examples 1-12 are described in more detail in Table 1.

TABLE 1
Characteristics of Milled Powders of Comparator
Examples 1-2 and Examples 1-12

| | | | | 10^{th} | 90^{th} | |
|---|---|---|---|---|---|---|
| | Polymeric | Median | | Percentile | Percentile | |
| | Surfactant - | Particle | Standard | Particle | Particle | |
| | Amount | Size | Deviation | Size | Size | PDI (by |
| Example | (wt. %) | (microns) | (microns) | (microns) | (microns) | volume) |
| Comparator | N/A | 9.567 | 15.2 | 1.006 | 48.36 | 0.754 |
| Example 1 | | | | | | |
| Comparator | N/A | 8.609 | 29.23 | 0.989 | 95.48 | |
| Example 2 | | | | | | |
| Example 1 | TX-100 - 1 | 2.134 | 2.068 | 0.844 | 8.460 | |
| Example 2 | TX-100 - 2 | 1.671 | 2.028 | 0.688 | 9.780 | |
| Example 3 | PEG400 - 2.5 | 1.954 | 1.695 | 0.784 | 6.689 | |
| Example 4 | PEG400 - 5 | 1.535 | 1.549 | 0.749 | 7.485 | |
| Example 5 | PVP40 - 5 | 3.704 | 5.068 | 1.052 | 14.78 | 0.666 |
| Example 6 | PVP40 - 10 | 1.204 | 1.232 | 0.706 | 6.860 | 0.187 |
| Example 7 | PVP40 - 15 | 1.166 | 1.429 | 0.696 | 10.63 | 0.185 |
| Example 8 | PVP40 - 20 | 1.152 | 1.403 | 0.698 | 11.01 | 0.175 |
| Example 9 | PVP8 - 5 | 1.476 | 1.418 | 0.751 | 6.880 | 0.194 |
| Example 10 | PVP8 - 10 | 1.199 | 1.142 | 0.719 | 7.267 | 0.136 |
| Example 11 | PVP8 - 15 | 1.154 | 0.977 | 0.689 | 4.507 | 0.097 |
| Example 12 | PVP8 - 20 | 1.087 | 1.029 | 0.641 | 5.296 | 0.095 |

As shown in Table 1, the particle size distribution after milling (e.g., the distribution between the 10^{th} percentile and the 90^{th} percentile) was narrower when polymeric surfactants were used (e.g., the distribution without polymeric surfactants was approximately 3.5-25 times wider than the distribution with polymeric surfactants).

As shown in Table 1, the median particle size after milling was smaller when polymeric surfactants were used (e.g., the median particle size without polymeric surfactants was approximately 2.3-8.8 times larger than the median particle size with polymeric surfactants).

As shown in Table 1, as the concentration of a given polymeric surfactant increased, the median particle size generally decreased.

Without wishing to be bound by any particular theory, it is believed that the Li₂₂SiP₂S₁₈ particles were surface-functionalized with the polymeric surfactants, such that when the particles get near one another, the polymer segments penetrate, causing steric stabilization, such that the particles are able to get closer to one another and may fuse to one another.

### Example 13

This Example describes coating an electrode with a slurry comprising the milled powder of Example 10. This Example demonstrates that coating an electrode with a slurry comprising the milled powder of Example 10 results in a uniform coating comprising the polymeric surfactant.

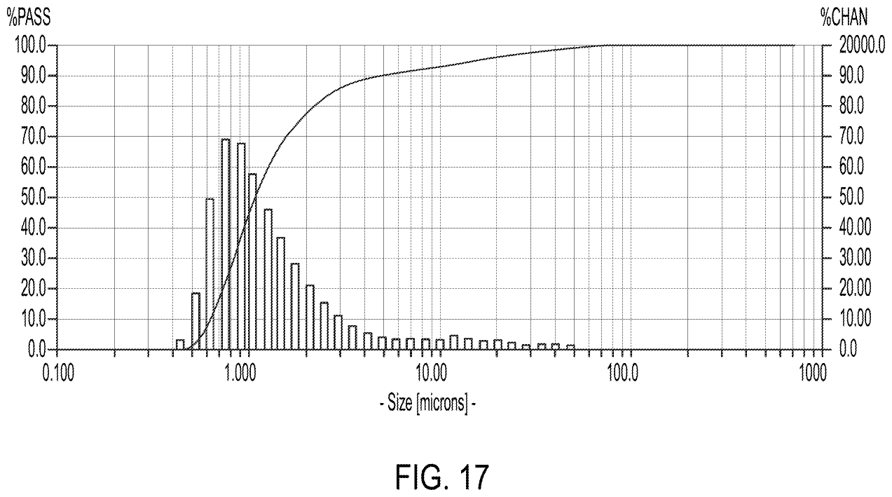

The milled powder of Example 10 (which was made with 10 wt. % PVP8) was dispersed into dimethyl carbonate (DMC) to form a stable slurry. The slurry was cast onto vacuum deposited lithium. It was dried at room temperature in a dry room. As shown in FIG. 18, the resulting coating was very uniform.

SEM/EDS of the coating demonstrated that carbon was distributed uniformly, which indicates that the polymeric surfactant was distributed uniformly in the coating.

### Example 14

This Example describes coating an electrode using an aerosol deposition method (ADM) with a powder milled with a polymeric surfactant. This Example demonstrates that coating an electrode using ADM with a powder milled with a polymeric surfactant results in a uniform coating comprising the polymeric surfactant.

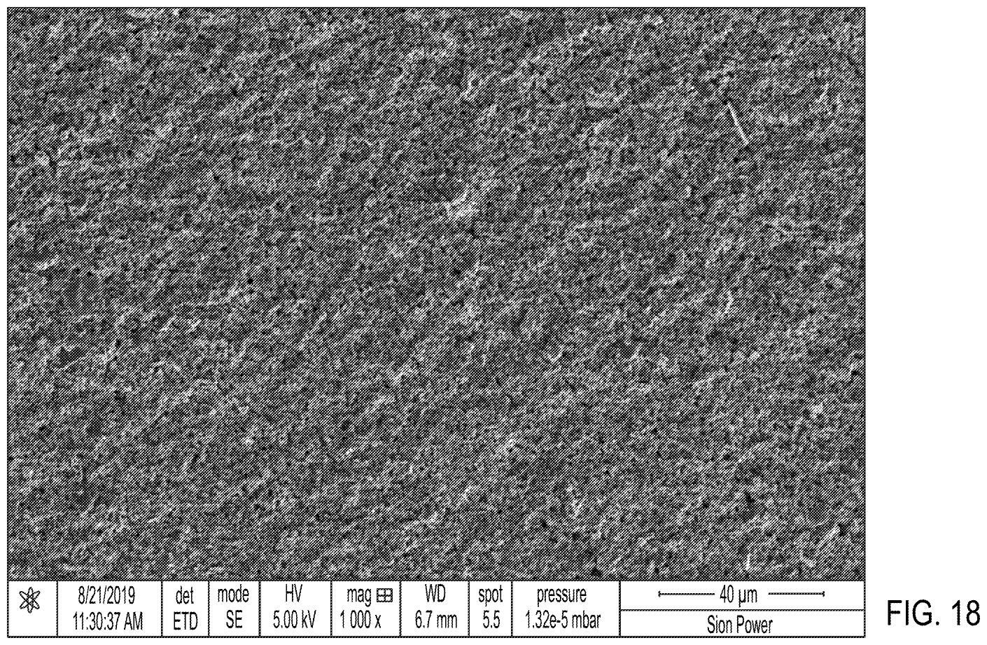

A raw sulfide solid electrolyte powder (Li₂₂SiP₂S₁₈) was mechanically milled using a high energy planetary ball mill as described in Example 6 (e.g., using 10 wt. % PVP40). The resulting milled powder had a median particle size of 1.2 microns, as shown in FIG. 19.

The milled powder was then transferred from the feeder by gas for an aerosol deposition method (ADM) coating process. The particles were separated by diameter, such that only particles with a diameter below 5-10 microns went into the ADM coating process while bigger particles remained in the feed. Vacuum deposited lithium anodes with 5 micron lithium thickness were ADM coated with a 3-5 micron thick layer comprising the Li₂₂SiP₂S₁₈ particles/PVP40 layer.

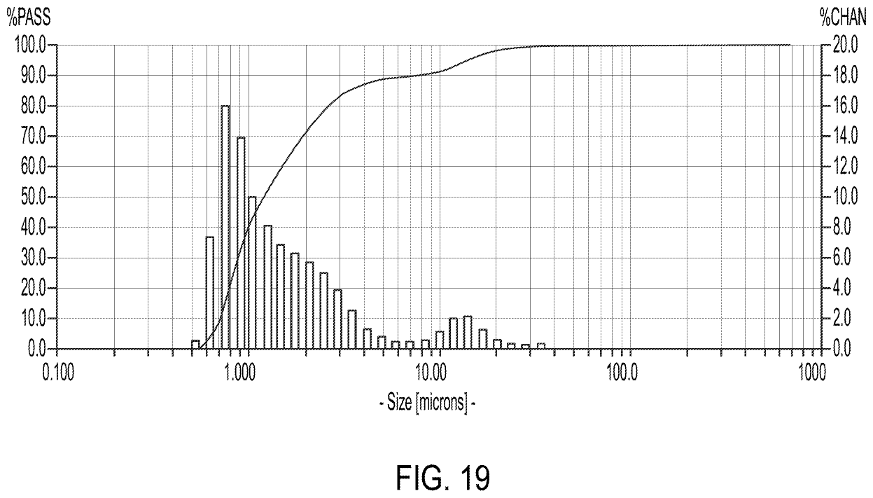

FIG. 20 is an SEM image of the coated anode. In FIG. 20, the dark areas are areas where the particles are fused. Some particles can be seen on top of the fused areas in FIG. 20, indicating that the particles in the coating were mainly fused with some non-fused particles on the surface of the layer.

EDS analyses of the anode demonstrated that PVP was in the coating and was uniformly distributed.

### Example 15 and Comparator Example 3

This Example studied the cycle life of electrochemical cells comprising the coated anode of Example 14 compared to electrochemical cells without the coating/layer, all other factors being equal. This Example demonstrates that use of electrodes with the coating/layer increased the cycle life.

The coated anodes of Example 14 were assembled into pouch cells with an NCM811 cathode and a polyolefin porous separator. The cells were filled with an electrolyte containing dimethylcarbonate and fluoroethylene carbonate as solvents, and LiPF₆ and lithium bis(oxalatoborate) as salts. The cells' total active electrode area was 99.4 cm².

Comparator Example 3 was an electrochemical cell identical to that of Example 15 except the anode did not have the ADM coating/layer.

The electrochemical cells were cycled at a pressure of 12 kg/cm². The cells were charged at 30 mA to 4.35 V and discharged at 120 mA to 3.2 V. The cells had an initial discharge capacity of 405 mAh. The cycling was stopped when the discharge capacity decreased to 250 mAh. Example 15 (i.e., the electrochemical cells with the ADM coated anodes) completed 94 cycles before reaching a discharge capacity of 250 mAh, while Comparator Example 3 (i.e., the electrochemical cells without the ADM coating) completed 83 cycle before reaching a discharge capacity of 250 mAh. Accordingly, use of the ADM coated anodes in the electrochemical cell increased cycle life by over 13%.

### Example 16

This Example describes how Li₂₂SiP₂S₁₈ (as used in Examples 1-12 and 14, and Comparator Examples 1-2) was synthesized.

Li₂S, P₂S₅, Si, and S were grinded, sieved, and roll milled. The mixture was then sealed in a tube reactor under Argon and sintered at 700° C. for 16 hours. The mixture was then cooled down to room temperature. The mixture was then crushed, grinded, and sieved (Sieve #80) to form a Li₂₂SiP₂S₁₈ powder with a median diameter of less than 177 microns. The powder was then milled in a planetary ball mill in heptane at 500 rpm for 4 hours to form Li₂₂SiP₂S₁₈ powder with a median diameter of less than or equal to 10 microns.

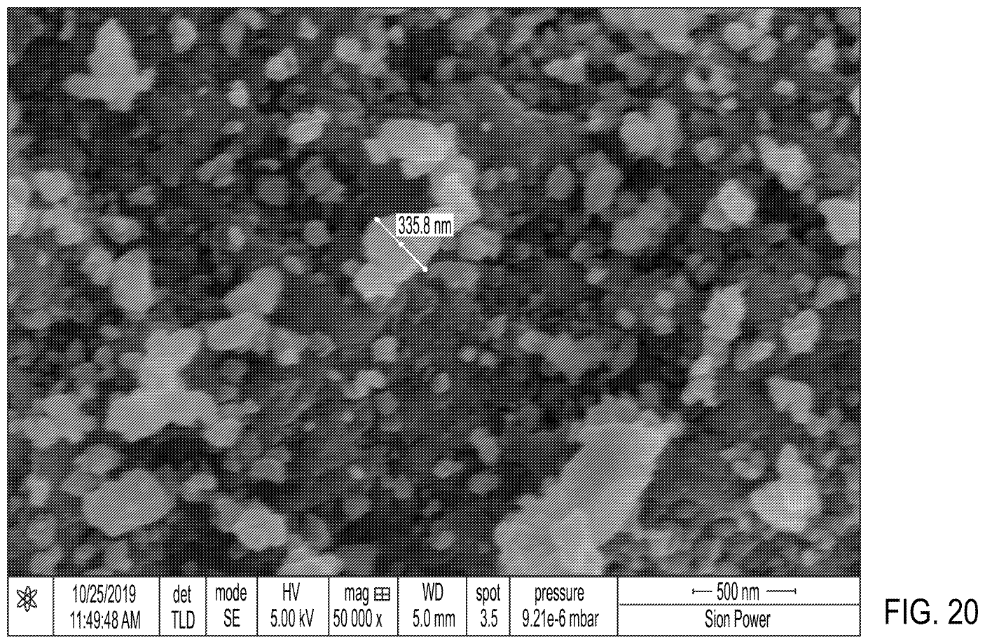

The resulting powder had a conductivity at room temperature of 7×10⁻⁴ S/cm and was stable in dry air. The XRD pattern (FIG. 21) of the resulting powder shows that the main phase was lithium argyrodite (Li₇PS₆) and the minor phase was Li₂S.

### Example 17

This Example describes coating a separator using an aerosol deposition method (ADM) with a powder milled with a polymeric surfactant. This Example demonstrates that coating a separator using ADM with a powder milled with a polymeric surfactant results in a uniform coating comprising the polymeric surfactant.

A raw sulfide solid electrolyte powder (Li₂₂SiP₂S₁₈) was mechanically milled using a high energy planetary ball mill as described in Example 6 (e.g., using 10 wt. % PVP40). The resulting milled powder had a submicron median particle size.

The milled powder was then transferred from the feeder by gas for an aerosol deposition method (ADM) coating process. The particles were separated by diameter, such that only particles with a diameter below 5-10 microns went into the ADM coating process while bigger particles remained in the feed. A polypropylene separator was ADM coated with a 3-5 micron thick layer comprising the Li₂₂SiP₂S₁₈ particles/PVP40 layer.

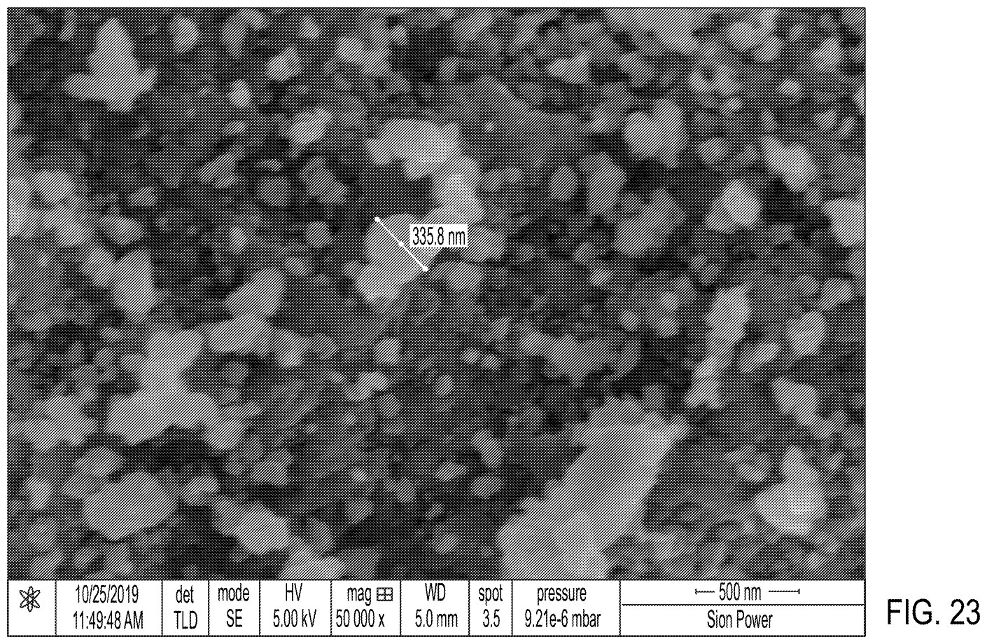

FIG. 23 is an SEM image of the coated separator. In FIG. 23, the dark areas are areas where the particles are fused. Some particles can be seen on top of the fused areas in FIG. 23, indicating that the particles in the coating were mainly fused with some non-fused particles on the surface of the layer.

EDS analyses of the anode demonstrated that PVP was in the coating and was uniformly distributed.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

### INCORPORATED BY REFERENCE

The following applications are incorporated herein by reference, in their entirety, for all purposes: U.S. Publication No. US-2007-0221265-A1 published on Sep. 27, 2007, filed as U.S. application Ser. No. 11/400,781 on Apr. 6, 2006, and entitled “RECHARGEABLE LITHIUM/WATER, LITHIUM/AIR BATTERIES”; U.S. Publication No. US-2009-0035646-A1, published on Feb. 5, 2009, filed as U.S. application Ser. No. 11/888,339 on Jul. 31, 2007, and entitled “SWELLING INHIBITION IN BATTERIES”; U.S. Publication No. US-2010-0129699-A1 published on May 17, 2010, filed as U.S. application Ser. No. 12/312,764 on Feb. 2, 2010; patented as U.S. Pat. No. 8,617,748 on Dec. 31, 2013, and entitled “SEPARATION OF ELECTROLYTES”; U.S. Publication No. US-2010-0291442-A1 published on Nov. 18, 2010, filed as U.S. application Ser. No. 12/682,011 on Jul. 30, 2010, patented as U.S. Pat. No. 8,871,387 on Oct. 28, 2014, and entitled “PRIMER FOR BATTERY ELECTRODE”; U.S. Publication No. US-2009-0200986-A1 published on Aug. 13, 2009, filed as U.S. application Ser. No. 12/069,335 on Feb. 8, 2008, patented as U.S. Pat. No. 8,264,205 on Sep. 11, 2012, and entitled “CIRCUIT FOR CHARGE AND/OR DISCHARGE PROTECTION IN AN ENERGY-STORAGE DEVICE”; U.S. Publication No. US-2007-0224502-A1 published on Sep. 27, 2007, filed as U.S. application Ser. No. 11/400,025 on Apr. 6, 2006, patented as U.S. Pat. No. 7,771,870 on Aug. 10, 2010, and entitled “ELECTRODE PROTECTION IN BOTH AQUEOUS AND NON-AQUEOUS ELECTROCHEMICAL CELLS, INCLUDING RECHARGEABLE LITHIUM BATTERIES”; U.S. Publication No. US-2008-0318128-A1 published on Dec. 25, 2008, filed as U.S. application Ser. No. 11/821,576 on Jun. 22, 2007, and entitled “LITHIUM ALLOY/SULFUR BATTERIES”; U.S. Publication No. US-2002-0055040-A1 published on May 9, 2002, filed as U.S. application Ser. No. 09/795,915 on Feb. 27, 2001, patented as U.S. Pat. No. 7,939,198 on May 10, 2011, and entitled “NOVEL COMPOSITE CATHODES, ELECTROCHEMICAL CELLS COMPRISING NOVEL COMPOSITE CATHODES, AND PROCESSES FOR FABRICATING SAME”; U.S. Publication No. US-2006-0238203-A1 published on Oct. 26, 2006, filed as U.S. application Ser. No. 11/111,262 on Apr. 20, 2005, patented as U.S. Pat. No. 7,688,075 on Mar. 30, 2010, and entitled “LITHIUM SULFUR RECHARGEABLE BATTERY FUEL GAUGE SYSTEMS AND METHODS”; U.S. Publication No. US-2008-0187663-A1 published on Aug. 7, 2008, filed as U.S. application Ser. No. 11/728,197 on Mar. 23, 2007, patented as U.S. Pat. No. 8,084,102 on Dec. 27, 2011, and entitled “METHODS FOR CO-FLASH EVAPORATION OF POLYMERIZABLE MONOMERS AND NON-POLYMERIZABLE CARRIER SOLVENT/SALT MIXTURES/SOLUTIONS”; U.S. Publication No. US-2011-0006738-A1 published on Jan. 13, 2011, filed as U.S. application Ser. No. 12/679,371 on Sep. 23, 2010, and entitled “ELECTROLYTE ADDITIVES FOR LITHIUM BATTERIES AND RELATED METHODS”; U.S. Publication No. US-2011-0008531-A1 published on Jan. 13, 2011, filed as U.S. application Ser. No. 12/811,576 on Sep. 23, 2010, patented as U.S. Pat. No. 9,034,421 on May 19, 2015, and entitled “METHODS OF FORMING ELECTRODES COMPRISING SULFUR AND POROUS MATERIAL COMPRISING CARBON”; U.S. Publication No. US-2010-0035128-A1 published on Feb. 11, 2010, filed as U.S. application Ser. No. 12/535,328 on Aug. 4, 2009, patented as U.S. Pat. No. 9,105,938 on Aug. 11, 2015, and entitled “APPLICATION OF FORCE IN ELECTROCHEMICAL CELLS”; U.S. Publication No. US-2011-0165471-A9 published on Jul. 15, 2011, filed as U.S. application Ser. No. 12/180,379 on Jul. 25, 2008, and entitled “PROTECTION OF ANODES FOR ELECTROCHEMICAL CELLS”; U.S. Publication No. US-2006-0222954-A1 published on Oct. 5, 2006, filed as U.S. application Ser. No. 11/452,445 on Jun. 13, 2006, patented as U.S. Pat. No. 8,415,054 on Apr. 9, 2013, and entitled “LITHIUM ANODES FOR ELECTROCHEMICAL CELLS”; U.S. Publication No. US-2010-0239914-A1 published on Sep. 23, 2010, filed as U.S. application Ser. No. 12/727,862 on Mar. 19, 2010, and entitled “CATHODE FOR LITHIUM BATTERY”; U.S. Publication No. US-2010-0294049-A1 published on Nov. 25, 2010, filed as U.S. application Ser. No. 12/471,095 on May 22, 2009, patented as U.S. Pat. No. 8,087,309 on Jan. 3, 2012, and entitled “HERMETIC SAMPLE HOLDER AND METHOD FOR PERFORMING MICROANALYSIS UNDER CONTROLLED ATMOSPHERE ENVIRONMENT”; U.S. Publication No. US-2011-0076560-A1 published on Mar. 31, 2011, filed as U.S. application Ser. No. 12/862,581 on Aug. 24, 2010, and entitled “ELECTROCHEMICAL CELLS COMPRISING POROUS STRUCTURES COMPRISING SULFUR”; U.S. Publication No. US-2011-0068001-A1 published on Mar. 24, 2011, filed as U.S. application Ser. No. 12/862,513 on Aug. 24, 2010, and entitled “RELEASE SYSTEM FOR ELECTROCHEMICAL CELLS”; U.S. Publication No. US-2012-0048729-A1 published on Mar. 1, 2012, filed as U.S. application Ser. No. 13/216,559 on Aug. 24, 2011, and entitled “ELECTRICALLY NON-CONDUCTIVE MATERIALS FOR ELECTROCHEMICAL CELLS”; U.S. Publication No. US-2011-0177398-A1 published on Jul. 21, 2011, filed as U.S. application Ser. No. 12/862,528 on Aug. 24, 2010, patented as U.S. Pat. No. 10,629,947 on Apr. 21, 2020, and entitled “ELECTROCHEMICAL CELL”; U.S. Publication No. US-2011-0070494-A1 published on Mar. 24, 2011, filed as U.S. application Ser. No. 12/862,563 on Aug. 24, 2010, and entitled “ELECTROCHEMICAL CELLS COMPRISING POROUS STRUCTURES COMPRISING SULFUR”; U.S. Publication No. US-2011-0070491-A1 published on Mar. 24, 2011, filed as U.S. application Ser. No. 12/862,551 on Aug. 24, 2010, and entitled “ELECTROCHEMICAL CELLS COMPRISING POROUS STRUCTURES COMPRISING SULFUR”; U.S. Publication No. US-2011-0059361-A1 published on Mar. 10, 2011, filed as U.S. application Ser. No. 12/862,576 on Aug. 24, 2010, patented as U.S. Pat. No. 9,005,809 on Apr. 14, 2015, and entitled “ELECTROCHEMICAL CELLS COMPRISING POROUS STRUCTURES COMPRISING SULFUR”; U.S. Publication No. US-2012-0052339-A1 published on Mar. 1, 2012, filed as U.S. application Ser. No. 13/216,579 on Aug. 24, 2011, and entitled “ELECTROLYTE MATERIALS FOR USE IN ELECTROCHEMICAL CELLS”; U.S. Publication No. US-2012-0070746-A1 published on Mar. 22, 2012, filed as U.S. application Ser. No. 13/240,113 on Sep. 22, 2011, and entitled “LOW ELECTROLYTE ELECTROCHEMICAL CELLS”; U.S. Publication No. US-2011-0206992-A1 published on Aug. 25, 2011, filed as U.S. application Ser. No. 13/033,419 on Feb. 23, 2011, and entitled “POROUS STRUCTURES FOR ENERGY STORAGE DEVICES”; U.S. Publication No. US-2012-0082872-A1 published on Apr. 5, 2012, filed as U.S. application Ser. No. 13/249,605 on Sep. 30, 2011, and entitled “ADDITIVE FOR ELECTROLYTES”; U.S. Publication No. US-2012-0082901-A1 published on Apr. 5, 2012, filed as U.S. application Ser. No. 13/249,632 on Sep. 30, 2011, and entitled “LITHIUM-BASED ANODE WITH IONIC LIQUID POLYMER GEL”; U.S. Publication No. US-2013-0164635-A1 published on Jun. 27, 2013, filed as U.S. application Ser. No. 13/700,696 on Mar. 6, 2013, patented as U.S. Pat. No. 9,577,243 on Feb. 21 2017, and entitled “USE OF EXPANDED GRAPHITE IN LITHIUM/SULPHUR BATTERIES”; U.S. Publication No. US-2013-0017441-A1 published on Jan. 17, 2013, filed as U.S. application Ser. No. 13/524,662 on Jun. 15, 2012, patented as U.S. Pat. No. 9,548,492 on Jan. 17, 2017, and entitled “PLATING TECHNIQUE FOR ELECTRODE”; U.S. Publication No. US-2013-0224601-A1 published on Aug. 29, 2013, filed as U.S. application Ser. No. 13/766,862 on Feb. 14, 2013, patented as U.S. Pat. No. 9,077,041 on Jul. 7, 2015, and entitled “ELECTRODE STRUCTURE FOR ELECTROCHEMICAL CELL”; U.S. Publication No. US-2013-0252103-A1 published on Sep. 26, 2013, filed as U.S. application Ser. No. 13/789,783 on Mar. 8, 2013, patented as U.S. Pat. No. 9,214,678 on Dec. 15, 2015, and entitled “POROUS SUPPORT STRUCTURES, ELECTRODES CONTAINING SAME, AND ASSOCIATED METHODS”; U.S. Publication No. US-2015-0287998-A1 published on Oct. 8, 2015, filed as U.S. application Ser. No. 14/743,304 on Jun. 18, 2015, patented as U.S. Pat. No. 9,577,267 on Feb. 21, 2017, and entitled “ELECTRODE STRUCTURE AND METHOD FOR MAKING SAME”; U.S. Publication No. US-2013-0095380-A1 published on Apr. 18, 2013, filed as U.S. application Ser. No. 13/644,933 on Oct. 4, 2012, patented as U.S. Pat. No. 8,936,870 on Jan. 20, 2015, and entitled “ELECTRODE STRUCTURE AND METHOD FOR MAKING THE SAME”; U.S. Publication No. US-2012-0052397-A1 published on Mar. 1, 2012, filed as U.S. application Ser. No. 13/216,538 on Aug. 24, 2011, patented as U.S. Pat. No. 9,853,287 on Dec. 26, 2017, and entitled “ELECTROLYTE MATERIALS FOR USE IN ELECTROCHEMICAL CELLS”; U.S. Publication No. US-2014-0123477-A1 published on May 8, 2014, filed as U.S. application Ser. No. 14/069,698 on Nov. 1, 2013, patented as U.S. Pat. No. 9,005,311on Apr. 14, 2015, and entitled “ELECTRODE ACTIVE SURFACE PRETREATMENT”; U.S. Publication No. US-2014-0193723-A1 published on Jul. 10, 2014, filed as U.S. application Ser. No. 14/150,156 on Jan. 8, 2014, patented as U.S. Pat. No. 9,559,348 on Jan. 31, 2017, and entitled “CONDUCTIVITY CONTROL IN ELECTROCHEMICAL CELLS”; U.S. Publication No. US-2014-0255780-A1 published on Sep. 11, 2014, filed as U.S. application Ser. No. 14/197,782 on Mar. 5, 2014, patented as U.S. Pat. No. 9,490,478 on Nov. 8, 2016, and entitled “ELECTROCHEMICAL CELLS COMPRISING FIBRIL MATERIALS”; U.S. Publication No. US-2014-0272594-A1 published on Sep. 18 2014, filed as U.S. application Ser. No. 13/833,377 on Mar. 15, 2013, and entitled “PROTECTIVE STRUCTURES FOR ELECTRODES”; U.S. Publication No. US-2014-0272597-A1 published on Sep. 18, 2014, filed as U.S. application Ser. No. 14/209,274 on Mar. 13, 2014, patented as U.S. Pat. No. 9,728,768 on Aug. 8, 2017, and entitled “PROTECTED ELECTRODE STRUCTURES AND METHODS”; U.S. Publication No. US-2015-0280277-A1 published on Oct. 1, 2015, filed as U.S. application Ser. No. 14/668,102 on Mar. 25, 2015, patented as U.S. Pat. No. 9,755,268 on Sep. 5, 2017, and entitled “GEL ELECTROLYTES AND ELECTRODES”; U.S. Publication No. US-2015-0180037-A1 published on Jun. 25, 2015, filed as U.S. application Ser. No. 14/576,570 on Dec. 19, 2014, patented as U.S. Pat. No. 10,020,512 on Jul. 10, 2018, and entitled “POLYMER FOR USE AS PROTECTIVE LAYERS AND OTHER COMPONENTS IN ELECTROCHEMICAL CELLS”; U.S. Publication No. US-2015-0349310-A1 published on Dec. 3, 2015, filed as U.S. application Ser. No. 14/723,132 on May 27, 2015, patented as U.S. Pat. No. 9,735,411 on Aug. 15, 2017, and entitled “POLYMER FOR USE AS PROTECTIVE LAYERS AND OTHER COMPONENTS IN ELECTROCHEMICAL CELLS”; U.S. Publication No. US-2014-0272595-A1 published on Sep. 18, 2014, filed as U.S. application Ser. No. 14/203,802 on Mar. 11, 2014, and entitled “COMPOSITIONS FOR USE AS PROTECTIVE LAYERS AND OTHER COMPONENTS IN ELECTROCHEMICAL CELLS”; U.S. Publication No. US-2019-0006699-A1 published on Jan. 3, 2019, filed as U.S. application Ser. No. 15/727,438 on Oct. 6, 2017, and entitled “PRESSURE AND/OR TEMPERATURE MANAGEMENT IN ELECTROCHEMICAL SYSTEMS”; U.S. Publication No. US-2014-0193713-A1 published on Jul. 10, 2014, filed as U.S. application Ser. No. 14/150,196 on Jan. 8, 2014, patented as U.S. Pat. No. 9,531,009 on Dec. 27, 2016, and entitled “PASSIVATION OF ELECTRODES IN ELECTROCHEMICAL CELLS”; U.S. Publication No. US-2014-0127577-A1 published on May 8, 2014, filed as U.S. application Ser. No. 14/068,333 on Oct. 31, 2013, patented as U.S. Pat. No. 10,243,202 on Mar. 26, 2019, and entitled “POLYMERS FOR USE AS PROTECTIVE LAYERS AND OTHER COMPONENTS IN ELECTROCHEMICAL CELLS”; U.S. Publication No. US-2015-0318539-A1 published on Nov. 5, 2015, filed as U.S. application Ser. No. 14/700,258 on Apr. 30, 2015, patented as U.S. Pat. No. 9,711,784 on Jul. 18, 2017, and entitled “ELECTRODE FABRICATION METHODS AND ASSOCIATED SYSTEMS AND ARTICLES”; U.S. Publication No. US-2014-0272565-A1 published on Sep. 18, 2014, filed as U.S. application Ser. No. 14/209,396 on Mar. 13, 2014, and entitled “PROTECTED ELECTRODE STRUCTURES”; U.S. Publication No. US-2015-0010804-A1 published on Jan. 8, 2015, filed as U.S. application Ser. No. 14/323,269 on Jul. 3, 2014, patented as U.S. Pat. No. 9,994,959 on Jun. 12, 2018, and entitled “CERAMIC/POLYMER MATRIX FOR ELECTRODE PROTECTION IN ELECTROCHEMICAL CELLS, INCLUDING RECHARGEABLE LITHIUM BATTERIES”; U.S. Publication No. US-2015-0162586-A1 published on Jun. 11, 2015, filed as U.S. application Ser. No. 14/561,305 on Dec. 5, 2014, and entitled “NEW SEPARATOR”; U.S. Publication No. US-2015-0044517-A1 published on Feb. 12, 2015, filed as U.S. application Ser. No. 14/455,230 on Aug. 8, 2014, patented as U.S. Pat. No. 10,020,479 on Jul. 10, 2018, and entitled “SELF-HEALING ELECTRODE PROTECTION IN ELECTROCHEMICAL CELLS”; U.S. Publication No. US-2015-0236322-A1 published on Aug. 20, 2015, filed as U.S. application Ser. No. 14/184,037 on Feb. 19, 2014, patented as U.S. Pat. No. 10,490,796 on Nov. 26, 2019, and entitled “ELECTRODE PROTECTION USING ELECTROLYTE-INHIBITING ION CONDUCTOR”; U.S. Publication No. US-2015-0236320-A1 published on Aug. 20, 2015, filed as U.S. application Ser. No. 14/624/641 on Feb. 18, 2015, patented as U.S. Pat. No. 9,653,750 on May 16, 2017, and entitled “ELECTRODE PROTECTION USING A COMPOSITE COMPRISING AN ELECTROLYTE-INHIBITING ION CONDUCTOR”; U.S. Publication No. US-2016-0118638-A1 published on Apr. 28, 2016, filed as U.S. application Ser. No. 14/921,381 on Oct. 23, 2015, and entitled “COMPOSITIONS FOR USE AS PROTECTIVE LAYERS AND OTHER COMPONENTS IN ELECTROCHEMICAL CELLS”; U.S. Publication No. US-2016-0118651-A1 published on Apr. 28, 2016, filed as U.S. application Ser. No. 14/918,672 on Oct. 21, 2015, and entitled “ION-CONDUCTIVE COMPOSITE FOR ELECTROCHEMICAL CELLS”; U.S. Publication No. US-2016-0072132-A1 published on Mar. 10, 2016, filed as U.S. application Ser. No. 14/848/659 on Sep. 9, 2015, and entitled “PROTECTIVE LAYERS IN LITHIUM-ION ELECTROCHEMICAL CELLS AND ASSOCIATED ELECTRODES AND METHODS”; U.S. Publication No. US-2018-0138542-A1 published on May 17, 2018, filed as U.S. application Ser. No. 15/567/534 on Oct. 18, 2017, and entitled “GLASS-CERAMIC ELECTROLYTES FOR LITHIUM-SULFUR BATTERIES”; U.S. Publication No. US-2016-0344067-A1 published on Nov. 24, 2016, filed as U.S. application Ser. No. 15/160,191 on May 20, 2016, patented as U.S. Pat. No. 10,461,372 on Oct. 29, 2019, and entitled “PROTECTIVE LAYERS FOR ELECTROCHEMICAL CELLS”; U.S. Publication No. US-2020-0099108-A1 published on Mar. 26, 2020, filed as U.S. application Ser. No. 16/587,939 on Sep. 30, 2019, and entitled “PROTECTIVE LAYERS FOR ELECTROCHEMICAL CELLS”; U.S. Publication No. US-2017-0141385-A1 published on May 18, 2017, filed as U.S. application Ser. No. 15/343,890 on Nov. 4, 2016, and entitled “LAYER COMPOSITE AND ELECTRODE HAVING A SMOOTH SURFACE, AND ASSOCIATED METHODS”; U.S. Publication No. US-2017-0141442-A1 published on May 18, 2017, filed as U.S. application Ser. No. 15/349,140 on Nov. 11, 2016, and entitled “ADDITIVES FOR ELECTROCHEMICAL CELLS”; patented as U.S. Pat. No. 10/320,031 on Jun. 11, 2019, and entitled “ADDITIVES FOR ELECTROCHEMICAL CELLS”; U.S. Publication No. US-2017-0149086-A1 published on May 25, 2017, filed as U.S. application Ser. No. 15/343,635 on Nov. 4, 2016, patented as U.S. Pat. No. 9,825,328 on Nov. 21, 2017, and entitled “IONICALLY CONDUCTIVE COMPOUNDS AND RELATED USES”; U.S. Publication No. US-2018-0337406-A1 published on Nov. 22, 2018, filed as U.S. application Ser. No. 15/983,352on May 18, 2018, and entitled “PASSIVATING AGENTS FOR ELECTROCHEMICAL CELLS”; U.S. Publication No. US-2018-0261820-A1 published on Sep. 13, 2018, filed as U.S. application Ser. No. 15/916,588 on Mar. 9, 2018, and entitled “ELECTROCHEMICAL CELLS COMPRISING SHORT-CIRCUIT RESISTANT ELECTRONICALLY INSULATING REGIONS”; U.S. Publication No. US-2020-0243824-A1 published on Jul. 30, 2020, filed as U.S. application Ser. No. 16/098,654 on Nov. 2, 2018, and entitled “COATINGS FOR COMPONENTS OF ELECTROCHEMICAL CELLS”; U.S. Publication No. US-2018-0351158-A1 published on Dec. 6, 2018, filed as U.S. application Ser. No. 15/983,363 on May 18, 2018, and entitled “PASSIVATING AGENTS FOR ELECTROCHEMICAL CELLS”; U.S. Publication No. US-2018-0277850-A1, published on Sep. 27, 2018, filed as U.S. application Ser. No. 15/923,342 on Mar. 16, 2018, and patented as U.S. Pat. No. 10,720,648 on Jul. 21, 2020, and entitled “ELECTRODE EDGE PROTECTION IN ELECTROCHEMICAL CELLS”; U.S. Publication No. US-2018-0358651-A1, published on Dec. 13, 2018, filed as U.S. application Ser. No. 16/002,097 on Jun. 7, 2018, and patented as U.S. Pat. No. 10,608,278 on Mar. 31, 2020, and entitled “IN SITU CURRENT COLLECTOR”; U.S. Publication No. US-2017-0338475-A1, published on Nov. 23, 2017, filed as U.S. application Ser. No. 15/599,595 on May 19, 2017, and entitled “PROTECTIVE LAYERS FOR ELECTRODES AND ELECTROCHEMICAL CELLS”; U.S. Publication No. US-2019-0088958-A1, published on Mar. 21, 2019, filed as U.S. application Ser. No. 16/124,384 on Sep. 7, 2018, and entitled “PROTECTIVE MEMBRANE FOR ELECTROCHEMICAL CELLS”; U.S. Publication No. US-2019-0348672-A1, published on Nov. 14, 2019, filed as U.S. application Ser. No. 16/470,708 on Jun. 18, 2019, and entitled “PROTECTIVE LAYERS COMPRISING METALS FOR ELECTROCHEMICAL CELLS”; U.S. Publication No. US-2017-0200975-A1, published Jul. 13, 2017, filed as U.S. application Ser. No. 15/429, 439 on Feb. 10, 2017, and patented as U.S. Pat. No. 10,050,308 on Aug. 14, 2018, and entitled “LITHIUM-ION ELECTROCHEMICAL CELL, COMPONENTS THEREOF, AND METHODS OF MAKING AND USING SAME”; U.S. Publication No. US-2018-0351148-A1, published Dec. 6, 2018, filed as U.S. application Ser. No. 15/988,182 on May 24, 2018, and entitled “IONICALLY CONDUCTIVE COMPOUNDS AND RELATED USES”; U.S. Publication No. US-2018-0254516-A1, published Sep. 6, 2018, filed as U.S. application Ser. No. 15/765,362 on Apr. 2, 2018, and entitled “NON-AQUEOUS ELECTROLYTES FOR HIGH ENERGY LITHIUM-ION BATTERIES”; U.S. Publication No. US-2020-0044460-A1, published Feb. 6, 2020, filed as U.S. application Ser. No. 16,527,903 on Jul. 31, 2019, and entitled “MULTIPLEXED CHARGE DISCHARGE BATTERY MANAGEMENT SYSTEM”; U.S. Publication No. US-2020-0220146-A1, published Jul. 9, 2020, filed as U.S. application Ser. No. 16/724,586 on Dec. 23, 2019, and entitled “ISOLATABLE ELECTRODES AND ASSOCIATED ARTICLES AND METHODS”; U.S. Publication No. US-2020-0220149-A1, published Jul. 9, 2020, filed as U.S. application Ser. No. 16/724,596 on Dec. 23, 2019, and entitled “ELECTRODES, HEATERS, SENSORS, AND ASSOCIATED ARTICLES AND METHODS”; U.S. Publication No. US-2020-0220197-A1, published Jul. 9, 2020, filed as U.S. application Ser. No. 16/724,612 on Dec. 23, 2019, and entitled “FOLDED ELECTROCHEMICAL DEVICES AND ASSOCIATED METHODS AND SYSTEMS”.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A mixture, comprising:
a plurality of ceramic particles and a polymeric surfactant;
wherein the plurality of ceramic particles has a median diameter of greater than or equal to 600 nanometers and less than or equal to 6 microns.

2. The mixture of claim 1, wherein the polymeric surfactant has a molecular weight of greater than or equal to 300 g/mol.

3. A mixture, comprising:
a plurality of ceramic particles and a polymeric surfactant;
wherein the polymeric surfactant has a molecular weight of greater than or equal to 300 g/mol.

4. The mixture of claim 3, wherein the plurality of ceramic particles has a median diameter of greater than or equal to 600 nanometers and less than or equal to 6 microns.

5. The mixture of any preceding claim, wherein the mixture is a powder.

6. The mixture of any preceding claim, wherein the mixture is a slurry.

7. A layer, comprising:
a plurality of ceramic particles, wherein at least a portion of the plurality of particles are fused to one another, and a polymeric surfactant;
wherein prior to fusion, the plurality of ceramic particles has a median diameter of greater than or equal to 600 nanometers and less than or equal to 6 microns.

8. The layer of claim 7, wherein the polymeric surfactant has a molecular weight of greater than or equal to 300 g/mol.

9. A layer, comprising:
a plurality of ceramic particles, wherein at least a portion of the plurality of particles are fused to one another, and a polymeric surfactant;
wherein the polymeric surfactant has a molecular weight of greater than or equal to 300 g/mol.

10. The layer of claim 9, wherein prior to fusion, the plurality of ceramic particles has a median diameter of greater than or equal to 600 nanometers and less than or equal to 6 microns.

11. The layer of any one of claims 7-10, wherein at least a portion of the plurality of ceramic particles are bound to the polymeric surfactant.

12. The layer of any one of claims 7-11, wherein the layer is formed by an aerosol deposition method (ADM).

13. An electrochemical cell comprising the layer of any one of claims 7-12.

14. The electrochemical cell of claim 13, wherein the electrochemical cell comprises an electrode and the layer coats the electrode.

15. The electrochemical cell of any one of claims 13-14, wherein the electrochemical cell comprises a separator and the layer coats the separator.

16. A method, comprising:
milling a mixture comprising a plurality of ceramic particles and a polymeric surfactant to form a milled mixture;
wherein the plurality of ceramic particles has a median diameter of greater than or equal to 600 nanometers and less than or equal to 6 microns.

17. The method of claim 16, wherein the polymeric surfactant has a molecular weight of greater than or equal to 300 g/mol.

18. A method, comprising:
milling a mixture comprising a plurality of ceramic particles and a polymeric surfactant to form a milled mixture;
wherein the polymeric surfactant has a molecular weight of greater than or equal to 300 g/mol.

19. The method of claim 18, wherein the plurality of ceramic particles has a median diameter of greater than or equal to 600 nanometers and less than or equal to 6 microns.

20. The method of any one of claims 16-18, further comprising combining the milled mixture with a solvent.

21. The mixture of any one of claims 1-6, further comprising a solvent.

22. The mixture or method of any one of claims 20-21, wherein the solvent is chemically inert towards the plurality of ceramic particles and/or is nonpolar.

23. The mixture or method of any one of claims 20-22, wherein the mixture and/or milled mixture comprises greater than or equal to 30 wt % and less than or equal to 90 wt % solvent.

24. The mixture or method of any one of claims 20-23, wherein the mixture and/or milled mixture comprises greater than or equal to 40 wt % and less than or equal to 70 wt % solvent.

25. The mixture or method of any preceding claim, wherein the mixture and/or milled mixture comprises greater than or equal to 0.5 wt % and less than or equal to 50 wt % of the polymeric surfactant.

26. The mixture or method of any preceding claim, wherein the mixture and/or milled mixture comprises greater than or equal to 0.5 wt % and less than or equal to 40 wt % of the polymeric surfactant.

27. The mixture or method of any preceding claim, wherein the mixture and/or milled mixture comprises greater than or equal to 0.5 wt % and less than or equal to 30 wt % of the polymeric surfactant.

28. The mixture or method of any preceding claim, wherein the mixture and/or milled mixture comprises greater than or equal to 1 wt % and less than or equal to wt % of the polymeric surfactant.

29. The mixture or method of any preceding claim, wherein the mixture and/or milled mixture comprises greater than or equal to 5 wt % and less than or equal to 10 wt % of the polymeric surfactant.

30. The mixture or method of any preceding claim, wherein the plurality of ceramic particles is greater than or equal to 10 wt % and less than or equal to 70 wt % of the mixture and/or milled mixture.

31. The mixture or method of any preceding claim, wherein the plurality of ceramic particles is greater than or equal to 30 wt % and less than or equal to 60 wt % of the mixture and/or milled mixture.

32. The mixture or method of any preceding claim, wherein the amount of the polymeric surfactant in the mixture and/or milled mixture reduces the conductivity of the mixture and/or milled mixture by less than 50 times compared to a mixture and/or milled mixture without the polymeric surfactant, all other factors being equal.

33. The mixture or method of any preceding claim, wherein the mixture and/or milled mixture further comprises beads.

34. The mixture or method of claim 33, wherein the beads have an average hardness higher than an average hardness of the plurality of ceramic particles.

35. The mixture or method of any one of claims 33-34, wherein the beads comprise ZrO₂.

36. The mixture or method of any preceding claim, wherein at least 50% of the plurality of ceramic particles are not fused to one or more ceramic particles.

37. The mixture or method of any preceding claim, wherein at least 90% of the plurality of ceramic particles are not fused to one or more ceramic particles.

38. The mixture or method of any preceding claim, wherein at least 99% of the plurality of ceramic particles are not fused to one or more ceramic particles.

39. The method of any preceding claim, wherein the milling comprises mechanical milling.

40. The method of any preceding claim, further comprising drying the mixture.

41. The method of any preceding claim, further comprising separating the beads from the milled mixture to form a powder.

42. The method of any preceding claim, further comprising applying the milled mixture and/or powder to a substrate to form a layer disposed on the substrate.

43. The method of claim 42, wherein the substrate comprises an electrode and/or a separator.

44. The method of any one of claims 42-43, wherein the applying uses an aerosol deposition method (ADM).

45. The method of any one of claims 42-44, further comprising forming an electrochemical cell comprising the substrate.

46. The mixture, layer, electrochemical cell, or method of any preceding claim, wherein the polymeric surfactant has a molecular weight of greater than or equal to 400 g/mol.

47. The mixture, layer, electrochemical cell, or method of any preceding claim, wherein the polymeric surfactant has a molecular weight of greater than or equal to 500 g/mol.

48. The mixture, layer, electrochemical cell, or method of any preceding claim, wherein the polymeric surfactant has a molecular weight of greater than or equal to 1,000 g/mol.

49. The mixture, layer, electrochemical cell, or method of any preceding claim, wherein the polymeric surfactant has a molecular weight of greater than or equal to 2,000 g/mol.

50. The mixture, layer, electrochemical cell, or method of any preceding claim, wherein the plurality of ceramic particles comprises sulfides and/or oxides.

51. The mixture, layer, electrochemical cell, or method of any preceding claim, wherein the plurality of ceramic particles comprises Li₇La₃Zr₂O₁₂ (LLZO), Li₂₂SiP₂S₁₈, an antiperovskite, beta-alumina, a sulfide glass, an oxide glass, a lithium phosphorus oxinitride, a Li replaceable NASICON ceramic, Li_{1+x+y}AlₓTi₂₋ₓSi_{y}P_{3-y}O₁₂ where x is between 0 and 2 and y is between 0 and 1.25, Li₂O—Al₂O₃—SiO₂—P₂O₅—TiO₂—GeO₂, Li₂O—Al₂O₃—SiO₂—P₂O₅—TiO₂, and/or a lithium borosilicate glass.

52. The mixture, layer, electrochemical cell, or method of any preceding claim, wherein the plurality of ceramic particles has a median diameter of greater than or equal to 1 micron and less than or equal to 4 microns.

53. The mixture, layer, electrochemical cell, or method of any preceding claim, wherein 90% of the plurality of ceramic particles has a diameter of less than or equal to 30 microns.

54. The mixture, layer, electrochemical cell, or method of any preceding claim, wherein 90% of the plurality of ceramic particles has a diameter of less than or equal to 20 microns.

55. The mixture, layer, electrochemical cell, or method of any preceding claim, wherein the plurality of ceramic particles has a polydispersity index of less than or equal to 0.5.

56. The mixture, layer, electrochemical cell, or method of any preceding claim, wherein the plurality of ceramic particles has a narrower distribution in diameter than the same ceramic particles without the polymeric surfactant, all other factors being equal.

57. The mixture, layer, electrochemical cell, or method of any preceding claim, wherein the plurality of ceramic particles has an aspect ratio of greater than or equal to 1 and less than or equal to 10.

58. The mixture, layer, electrochemical cell, or method of claim 57, wherein the aspect ratio is greater than or equal to 1 and less than or equal to 5.

59. The mixture, layer, electrochemical cell, or method of any preceding claim, wherein the polymeric surfactant has a molecular weight of greater than or equal to 5,000 g/mol.

60. The mixture, layer, electrochemical cell, or method of any preceding claim, wherein the polymeric surfactant has a molecular weight of greater than or equal to 10,000 g/mol.

61. The mixture, layer, electrochemical cell, or method of any preceding claim, wherein the polymeric surfactant comprises polyacrylic acid, polyethylene glycol, polyvinylpyrrolidone, CMC, a silicon polymeric surfactant, a polysaccharide, a polysulfonate, a sulphonated styrene/maleic anhydride co-polymer, a polyacrylamide, polyvinylidene fluoride, and/or polyvinylidene chloride.

62. The mixture, layer, electrochemical cell, or method of any preceding claim, wherein the polymeric surfactant comprises PEG400, polyethylene glycol tert-octylphenyl ether, PVP40, and/or PVP8.

63. The mixture, layer, electrochemical cell, or method of any preceding claim, wherein an average contact angle of the plurality of ceramic particles and/or mixture is lower in the presence of the polymeric surfactant.

64. The mixture, layer, electrochemical cell, or method of claim 63, wherein the average contact angle is at least 10% lower when the polymeric surfactant is present.

65. The mixture, layer, electrochemical cell, or method of any one of claims 63-64, wherein the average contact angle is at least 20% lower when the polymeric surfactant is present.

66. The mixture, layer, electrochemical cell, or method of any one of claims 63-65, wherein the average contact angle is at least 30% lower when the polymeric surfactant is present.

67. The mixture, layer, electrochemical cell, or method of any preceding claim, wherein an average contact angle of the plurality of ceramic particles and/or mixture is less than 90 degrees when the polymeric surfactant is present.

68. The mixture, layer, electrochemical cell, or method of any preceding claim, wherein a carboxylic acid is absent from the polymeric surfactant.

69. The mixture, layer, electrochemical cell, or method of any preceding claim, wherein the polymeric surfactant does not react with lithium metal.

70. The mixture, layer, electrochemical cell, or method of any preceding claim, wherein the plurality of ceramic particles has a standard deviation in diameter of greater than or equal to 0 microns and less than or equal to 10 microns.

71. The mixture, layer, electrochemical cell, or method of any preceding claim, wherein the plurality of ceramic particles has a standard deviation in diameter of greater than or equal to 0 microns and less than or equal to 6 microns.

72. The electrochemical cell of any preceding claim, wherein the electrochemical cell comprises a battery.

73. The electrochemical cell of any preceding claim, wherein the electrochemical cell comprises an electrolyte.

74. The electrochemical cell of claim 73, wherein the electrolyte comprises a liquid electrolyte.

75. The electrochemical cell of any one of claims 73-74, wherein the electrolyte comprises an organic solvent.

76. The electrochemical cell of any one of claims 73-75, wherein the electrolyte comprises a lithium salt.

77. The electrochemical cell of any one of claims 73-76, wherein the polymeric surfactant is less than or equal to 5 wt. % soluble in the electrolyte.

78. The electrochemical cell of any one of claims 73-77, wherein the polymeric surfactant is less than or equal to 1 wt. % soluble in the electrolyte.

79. The electrochemical cell of any one of claims 73-78, wherein the polymeric surfactant does not react with the electrolyte.

80. The electrochemical cell of any one of claims 73-79, wherein the polymeric surfactant has high stability in the electrolyte.

81. The electrochemical cell of any preceding claim, wherein the electrochemical cell comprises one or more electrodes.

82. The electrochemical cell of claim 81, wherein the one or more electrodes comprises an anode.

83. The electrochemical cell of any one of claims 81-82, wherein the one or more electrodes and/or anode comprises lithium metal and/or a lithium alloy.

84. The electrochemical cell of any one of claims 81-83, wherein the one or more electrodes and/or anode comprises lithium metal.

85. The electrochemical cell of any one of claims 81-84, wherein the one or more electrodes comprises a cathode.

86. The electrochemical cell of any one of claims 81-85, wherein the one or more electrodes and/or the cathode comprises NCM811, an intercalation cathode, a Li-metal oxide intercalation cathode as NCM or LCO, a Li-metal phosphate intercalation cathode as LFP, and/or LiMnPO₄.

87. The electrochemical cell of any preceding claim, wherein the electrochemical cell comprises a separator.

88. The electrochemical cell of claim 87, wherein the separator comprises a polyolefin, a porous ceramic, a porous glass, and/or a porous polymer.

89. The electrochemical cell of any one of claims 87-88, wherein the separator is porous.

90. The layer, electrochemical cell, or method of any preceding claim, wherein the layer has a thickness of greater than or equal to 2 microns and less than or equal to 15 microns.

91. The layer, electrochemical cell, or method of any preceding claim, wherein the layer has a thickness of greater than or equal to 2 microns and less than or equal to 5 microns.

92. The layer, electrochemical cell, or method of any preceding claim, wherein a portion of the plurality of ceramic particles is bound to the polymeric surfactant.

93. The layer, electrochemical cell, or method of any preceding claim, wherein at least 30% of the plurality of ceramic particles are bound to the polymeric surfactant.

94. The layer, electrochemical cell, or method of any preceding claim, wherein at least 50% of the plurality of ceramic particles are bound to the polymeric surfactant.

95. The layer, electrochemical cell, or method of any preceding claim, wherein at least 80% of the plurality of ceramic particles are bound to the polymeric surfactant.

96. The layer, electrochemical cell, or method of any preceding claim, wherein at least 30% of the plurality of ceramic particles are fused to another ceramic particle.

97. The layer, electrochemical cell, or method of any preceding claim, wherein at least 50% of the plurality of ceramic particles are fused to another ceramic particle.

98. The layer, electrochemical cell, or method of any preceding claim, wherein at least 80% of the plurality of ceramic particles are fused to another ceramic particle.

99. The layer, electrochemical cell, or method of any preceding claim, wherein the layer is calendered.

100. The electrochemical cell of any preceding claim, wherein the electrochemical cell has an increased cycle life compared to an electrochemical cell without the layer, all other factors being equal.

101. The electrochemical cell of any preceding claim, wherein the electrochemical cell has greater than or equal to 105% of the cycle life of an electrochemical cell without the layer, all other factors being equal.

102. The electrochemical cell of any preceding claim, wherein the electrochemical cell has greater than or equal to 110% of the cycle life of an electrochemical cell without the layer, all other factors being equal.

103. The electrochemical cell of any preceding claim, wherein the electrochemical cell has greater than or equal to 200% of the cycle life of an electrochemical cell without the layer, all other factors being equal.

104. The electrochemical cell of any preceding claim, wherein the electrochemical cell has less than or equal to 500% of the cycle life of an electrochemical cell without the layer, all other factors being equal.
